(19) United States
(12) Patent Application Publication
(10) Pub. No.: US 2025/0368923 A1
(43) Pub. Date: Dec. 4, 2025

(54) PRE-MOISTENED ARTICLES FOR REFRESHING CLOTHING IN THE DRYER

(71) Applicant: The Clorox Company, Oakland, CA (US)

(72) Inventors: Bradley Kirsch, Pleasanton, CA (US); Fatima A. Hussain, Pleasanton, CA (US); Courtney M. Moore, Pleasanton, CA (US); Nikhil P. Dani, Pleasanton, CA (US); Lauren G. Axten, Pleasanton, CA (US); Mikayla Barry, Pleasanton, CA (US); Daniel P. Arnold, Pleasanton, CA (US)

(21) Appl. No.: 19/208,102

(22) Filed: May 14, 2025

Related U.S. Application Data
(60) Provisional application No. 63/652,803, filed on May 29, 2024.

(51) Int. Cl. C11D 3/00; C11D 1/72; C11D 3/20; C11D 3/30; C11D 3/32; C11D 3/34; C11D 3/37; C11D 17/04; D06F 58/20

(52) U.S. Cl. CPC C11D 3/001; C11D 1/72; C11D 3/2013; C11D 3/2079; C11D 3/30; C11D 3/32; C11D 3/349; C11D 3/3707; C11D 17/047; D06F 58/203

(57) ABSTRACT

Methods for providing a refresh treatment of fabric articles within a dryer. A refresh composition may include a fabric softener additive and/or surfactant. Various other adjuncts may also be included. The refresh composition may be dosed on a wipe, sponge, pad, sheet, cloth or the like. Such a wipe may be wet to the touch. The refresh composition may not include waxes or similar hydrophobic components typically included in existing fabric softener sheets. The refresh composition (e.g., on a dosed wipe) is placed into the dryer with one or more dry fabric articles, in order to refresh such fabric articles. Such fabric articles are already dry, not having been run through an immediately prior wash cycle. At least about 60% of the composition may be released from the wipe or other substrate quickly, within about 20 minutes, at a temperature of no greater than about 145° F., 135° F. or 120° F.

### CROSS-REFERENCE TO RELATED APPLICATIONS

This application claims the benefit of and priority to U.S. Provisional Patent Application Ser. No. 63/652,803 filed May 29, 2024, and entitled “PRE-MOISTENED ARTICLES FOR REFRESHING CLOTHING IN THE DRYER,” which application is expressly incorporated herein by reference in its entirety.

### BACKGROUND OF THE INVENTION

### 1. The Field of the Invention

The present invention relates to compositions for use in laundry e.g., particularly for use within a dryer (e.g., dryer sheets).

### 2. Description of Related Art

Various laundry treatments are available, e.g., typically for stain removal and the like. Many such treatment compositions are added to the wash water used to wash such fabrics or are used in pre-treating such fabrics prior to washing within the wash water of a washing machine. There is an emerging consumer behavior towards wearing clothing additional times before laundering versus the more traditional behavior of only wearing clothing once or a very few number of times before laundering (e.g., depending on the article of clothing). This emerging behavior also creates an opportunity to develop new types of products that would help drive consumer confidence in wearing clothing additional times without the need for a full laundering process of washing and drying.

While various dryer sheets are available on the market, such sheets are typically dry to the touch, and typically are configured as a waxy solid phase that requires application of relatively high temperature to melt, so that the chemistry provided within the dryer sheet can be deposited onto clothing during the dryer cycle. Such products and methods are problematic in that they require a full dryer cycle (e.g., often 45 to 60 minutes or more) to work, and are intended for use with wet clothing, taken directly from the washer, for deposition of such chemistry from the dryer sheet onto the clothing, as it is dried, during a full laundering cycle (i.e., washing followed by drying).

As such, there is a continuing need for alternative products that could be used to provide a “refresh” treatment to dry clothing articles, that have not just been through a wash cycle, and that would not require such high temperatures and long treatment times.

### BRIEF SUMMARY

In an embodiment, the present invention is directed to a method for providing a refresh treatment of fabric articles within a dryer (i.e., a fabric article drying appliance). The term “dryer” may be used herein for convenience. The population at large will appreciate that “dryer” refers to such a household appliance (or as found in a laundromat), available in the vast majority of homes within the United States, as well as in many other countries throughout the world. Such methods may include providing a dryer refresh composition dosed onto a wipe or other substrate, where the composition may include from about 0.5% to about 25%, about 0.5% to about 20%, about 0.5% to about 15%, about 0.5% to about 10%, or about 0.5% to about 5% by weight of a fabric softener additive. The composition may additionally or alternatively include from about 0.01% to about 15%, about 0.0.1% to about 10%, or about 0.01% to about 5% by weight of at least one surfactant (e.g., a nonionic, cationic or zwitterionic or amphoteric surfactant). The composition also includes water. The wipe or other substrate with the refresh composition dosed thereon may be wet to the touch. The method further includes introducing the wipe or other substrate dosed with the dryer refresh composition into the dryer with one or more dry fabric articles, in order to refresh such fabric articles without subjecting such fabric articles to a wash cycle. In particular, in an embodiment, already dry fabric articles are placed in the dryer and run through a relatively short cycle in the dryer with the refresh composition, even though no drying of the fabric articles is desired or is to be achieved. The refresh composition may be loaded onto a wipe or similar substrate (e.g., a sponge, a pad, a sheet, a cloth, or the like). The method further includes treating the one or more fabric articles in the dryer with the wipe or other dosed substrate, wherein at least 60% of the dryer refresh composition releases from the wipe within about 20 minutes, at a temperature of no greater than about 145° F., about 140° F., about 135° F., about 130° F., about 125° F. or about 120° F. Heat may or may not be added by the dryer (e.g., the dryer may be run at a short cycle under a “no heat” or “air fluff” type setting). Alternatively, a moderate amount of heat may be added, e.g., under a “low heat” setting. Higher heat settings may be used, although such is not needed, and in some embodiments may not be desirable. For example, such higher heat may cause a loss of functionality of some components of the dryer refresh composition, (e.g., where the composition intentionally includes fragrances, perfumes, essential oils, enzymes, probiotics, or other components that would exhibit a loss of functional properties at elevated temperature). In addition, such higher heat can be problematic where the fabric articles being treated may have some light soiling, as such higher heat could result in setting of such soil or stain within the fabric article, causing permanent damage thereto (i.e., the stain may not come out after drying at elevated temperature, as this sets the stain).

In an embodiment the refresh composition comprises (i) from about 0.5% to about 15% by weight of a fabric softening additive, (ii) from about 0.01% to about 15% by weight of at least one of a nonionic, cationic, or zwitterionic surfactant; and (iii) water.

In another embodiment the refresh composition comprises (i) from about 1% to about 3% by weight of a fabric softening additive, (ii) from about 0.3% to about 1% by weight of a nonionic surfactant; and (iii) greater than about 95% by weight water.

In another embodiment the refresh composition consists of (i) from about 1% to about 3% by weight of a fabric softener additive, (ii) from about 0.3% to about 1% by weight of a nonionic surfactant, (iii) greater than about 95% by weight water, and (iv) optionally, one or more of the following adjuncts selected from the group consisting of: fragrances or perfumes (including essential oils), antimicrobial actives, microbiostatic agents, fluorescent whitening agents, waterproofing agents, anti-pilling agents, probiotics, solvents, dyes or colorants, solubilizing materials, stabilizers, thickeners, defoamers, hydrotropes, buffers, builders, lotions or mineral oils, enzymes, cloud point modifiers, odor control additives, additional fabric softeners, antistatic agents, siloxanes, wrinkle release agents, allergen neutralization agents, skin-enhancing agents, allergen-free additives, fabric longevity enhancers, and preservatives. The composition dosed on the wipe or other substrate may be free or substantially free of waxes and fabric softeners that are dry solids at room temperature.

In another embodiment, the refresh composition comprises (i) from about 0.5% to about 25% by weight of a fabric softening additive, and (ii) water, and the refresh composition may have a viscosity from about 0.05 about cps to 1300 cps at 20° C.

In another embodiment the refresh composition comprises (i) from about 0.01% to about 15% by weight of at least one of a nonionic, cationic, or zwitterionic surfactant, (ii) from about 0.01% to about 4% by weight of at least one fragrance, perfume, or essential oil, and (iii) water.

Any of the described refresh compositions may be used in a refresh treatment in a dryer, where the wipe or other substrate with the refresh composition dosed thereon may be wet to the touch. The method may include placing the wipe or other substrate dosed with the dryer refresh composition into a fabric article drying appliance with one or more dry fabric articles in order to refresh such fabric articles without subjecting such fabric articles to a wash cycle, and treating the one or more fabric articles in the fabric article drying appliance with the wipe or other substrate dosed with the dryer refresh composition for a period of from about 1 minute to about 20 minutes at a temperature of no greater than about 145° F. In an embodiment, the temperature provided in the dryer may be no greater than, or less than about 145° F., about 140° F., about 135° F., about 130° F., about 125° F. or about 120° F., such as from about 70° F. to about 120° F., from about 70° F. to about 110° F., or from about 90° F. to about 110° F. Other ranges may of course be defined between any of the noted temperatures.

In any of the described embodiments, the fabric softening additive may comprise at least one of (i) an ester quat or other cationic fabric softener additive, (ii) a phosphate ester anionic fabric softener additive or other anionic fabric softener additive, or (iii) a fatty acid fabric softener additive or other non-ionic fabric softener additive.

In any of the described embodiments, an exemplary ester quat may comprise dialkyl ammonium methosulfate.

In any of the described embodiments, the fabric softening additive may be present in an amount of from about 0.5% to about 25%, 0.5% to about 20%, 0.5% to about 15%, about 0.5% to about 10%, from about 0.5% to about 5%, from about 1% to about 10%, or from about 1% to about 3% by weight.

In any of the described embodiments, the surfactant may comprise an alcohol ethoxylate nonionic surfactant.

In any of the described embodiments, the surfactant may be present in an amount of from about 0.01% to about 15%, about 0.01% to about 10%, from about 0.01% to about 5%, from about 0.3% to about 10% by weight, or from about 0.3% to about 1% by weight.

In any of the described embodiments, the refresh composition may further comprise a fragrance and/or non-fragrance odor control additive. Examples of non-fragrance odor control additives include, but are not limited to:
organic acids (e.g. citric acid and/or maleic acid) which can react with odor compounds to break them down and thereby reduce odors (this can also be accomplished via hydrogen peroxide, bleach, titanium dioxide, etc.);
ring-shaped molecules (e.g. cyclodextrins) that can trap odor compounds within their structures to reduce odor levels;
zinc ricinoleate that binds to odor compounds to reduce odor levels; and/or antimicrobial compounds (e.g. quats, metal compounds, or organic acids) that reduce or control bacteria that produce odor compounds.

In any of the described embodiments, any included fragrance, perfume or essential oil may be present in an amount of from greater than 0% to about 10% by weight, or greater than 0% to about 5% by weight, such as from about 0.01% to about 4% by weight or about 0.5% to about 3% by weight.

In any of the described embodiments, the composition may comprise a fragrance, perfume, essential oil, enzyme, probiotic, or other component that would exhibit a loss of functional properties at temperatures of greater than about 145° F., about 140° F., about 135° F., about 130° F., about 125° F. or about 120° F.

In any of the described embodiments, the water may be present in an amount of at least about 30%, at least about 40%, at least about 50%, at least about 60%, at least about 70%, at least about 80% or at least about 90% by weight. Such water may be present as free, unbound water.

In any of the described embodiments, the water may be present in an amount of at least about 95% by weight.

In any of the described embodiments, the fabric article drying appliance may provide a temperature to the one or more fabric articles and the dryer refresh composition that is no more than about 145° F., about 140° F., about 135° F., about 130° F., about 125° F. or about 120° F., such as from about 70° F. to about 110° F.

In any of the described embodiments, the fabric article drying appliance may provide a temperature to the one or more fabric articles and the dryer refresh composition that is from about 90° F. to about 110° F.

In any of the described embodiments, at least 50% by weight of the dryer refresh composition may release from the wipe or other substrate within about 10 minutes, or within about 5 minutes at a temperature of no greater than about 145° F., about 140° F., about 135° F., about 130° F., about 125° F. or about 120° F.

In any of the described embodiments, the one or more fabric articles may be treated in the fabric article drying appliance with the wipe or other substrate dosed with the dryer refresh composition for no more than about 15 minutes at a temperature of no greater than about 145° F., about 140° F., about 135° F., about 130° F., about 125° F. or about 120° F.

In any of the described embodiments, the one or more fabric articles may be treated in the fabric article drying appliance with the wipe or other substrate dosed with the dryer refresh composition for a period of time of from about 1 to about 15 minutes at a temperature of no greater than about 145° F., about 140° F., about 135° F., about 130° F., about 125° F. or about 120° F.

In any of the described embodiments, the one or more fabric articles may be treated in the fabric article drying appliance with the wipe or other substrate dosed with the dryer refresh composition for a period of time of from about 1 to about 10 minutes at a temperature of no greater than about 145° F., about 140° F., about 135° F., about 130° F., about 125° F. or about 120° F.

In any of the described embodiments, the one or more fabric articles may be treated in the fabric article drying appliance with the wipe or other substrate dosed with the dryer refresh composition for a period of time of from about 1 to about 5 minutes at a temperature of no greater than about 145° F., about 140° F., about 135° F., about 130° F., about 125° F. or about 120° F.

In any of the described embodiments, the wipe or other substrate may comprise at least one of structure containing fiber materials, a knit article, a woven article, a nonwoven article, a sponge, a pad, a sheet, a foam, or a cloth.

In any of the described embodiments, the refresh composition may be a liquid composition.

In any of the described embodiments, the refresh composition may be substantially or entirely free of materials derived from petrochemicals.

In any of the described embodiments, the refresh composition may be substantially or entirely derived from plant-based materials.

In any of the described embodiments, the refresh composition may not be corrosive to eyes per a Bovine Corneal Opacity and Permeability Assay (e.g., BCOP, OECD 437).

In any of the described embodiments, the refresh composition may not be corrosive to skin per a Skin Corrosion Test (e.g., OECD 431).

In any of the described embodiments, the refresh composition may be substantially or entirely free of allergens.

In any of the described embodiments, the refresh composition may have a viscosity from about 0.05 cps to about 1300 cps at 20° C. By way of example, a refresh composition having such a viscosity may include from about 0.5% to about 25% of the fabric softening additive. In such a composition the surfactant(s) and/or fragrance, perfume, and/or essential oil may be optional, or even excluded.

In any of the described embodiments, where both a fabric softening additive (e.g., an ester quat) and a surfactant (e.g., nonionic surfactant) are included, the fabric softening additive may account for at least 50%, such as from 50% to 95%, from 50% to 90%, from 60% to 80%, or from 65% to 75% of the combined amount of the fabric softening additive and the surfactant together.

Load size may vary widely, e.g., including a load as small as a single article of clothing or other single fabric article, and may typically range from at least about 0.25 lb, at least about 0.5 lb, at least about 1 lb, up to about 8 lbs, up to about 6 lbs, or up to about 4 lbs, such as about 1 lb, about 2 lbs, about 3 lbs, about 4 lbs, or other value.

In an embodiment, the composition may be free or substantially free of waxes or other waxy, hydrophobic fabric softener components that are dry solids at room temperature, typically employed in existing dryer sheet products. In an embodiment, the composition may be free or substantially free from cyclodextrins, water soluble polyionic polymers, pH adjusting mineral salts, zeolites, activated carbon, or other deodorizer agents such as those described in US 2009/0193593, herein incorporated by reference in its entirety. The composition may similarly be free of any other components present in other existing dryer sheet or other similar products. Furthermore, in an embodiment, the present compositions may be free or substantially free of biguanides or similar antimicrobial halogenated compounds, phenyl or phenolic compounds, or metallic salts (e.g., copper, zinc or silver inorganic or organic antimicrobial salts). In an embodiment the composition may be free or substantially free of lower alcohols (e.g., ethanol, propanol, isopropanol, etc.), diols (e.g., alkanediols), or any other component(s) not specifically mentioned herein.

A variety of additional adjunct components (e.g., in addition to the water, the fabric softener additive, and/or the surfactant) may be present. Examples of such include, but are not limited to fragrances or perfumes or essential oils (e.g., particularly those that may otherwise be unsuitable for use at higher than ambient temperature, where the “high notes” of such components may be lost), antimicrobial actives, microbiostatic agents, skin-enhancing agents, allergen-free additives, fabric longevity enhancers, fluorescent whitening agents, waterproofing agents, anti-pilling agents, probiotics, solvents, dyes or colorants, solubilizing materials, stabilizers, thickeners, defoamers, hydrotropes, buffers, builders, lotions or mineral oils, enzymes, cloud point modifiers, odor control additives, additional fabric softeners, antistatic agents, siloxanes, wrinkle release agents, allergen neutralization agents, and/or preservatives.

While a dosed wipe configuration may be particularly described, it will be appreciated that alternative configurations are also possible, including but not limited to dosing a structure containing fiber materials, a knit article, a woven article, a nonwoven article, a sponge, a pad, a sheet, a foam, or a cloth or the like.

Further features and advantages of the present invention will become apparent to those of ordinary skill in the art in view of the detailed description of preferred embodiments below.

### BRIEF DESCRIPTION OF THE DRAWINGS

To further clarify the above and other advantages and features of the present invention, a more particular description of the invention will be rendered by reference to specific embodiments thereof which are illustrated in the drawings located in the specification. It is appreciated that these drawings depict only typical embodiments of the invention and are therefore not to be considered limiting of its scope. The invention will be described and explained with additional specificity and detail through the use of the accompanying drawings.

FIGS. 1A-1B graphically show the impact of various factors on lotion release from an exemplary dosed wipe.

FIG. 2A shows grams of lotion released within the first minute of treatment for all collected data, across all tested conditions.

FIG. 2B shows grams of lotion released within the first minute of treatment at particular test conditions when using a polyethylene terephthalate (PET) wipe, at 120° F., with a 4 lb load size.

FIG. 3 shows percent lotion release after 1 minute, as well as percent lotion release between 10 minutes and 20 minutes, for various comparative and exemplary embodiments.

FIG. 4 shows marginal percent release per minute for an exemplary embodiment as compared to various comparative products.

FIG. 5 shows cumulative percentage lotion released over time for an exemplary embodiment as compared to various comparative products.

FIG. 6 shows rate of release (percent release per minute) versus time for an exemplary embodiment as compared to various comparative products.

FIG. 7A-7E show grams of lotion delivered at various times (1 minute, 2 minutes, 5 minutes, 10 minutes and 20 minutes) for an exemplary embodiment as compared to various comparative products.

FIG. 8A shows grams of lotion delivered at various treatment times (1 minute, 10 minutes, and 20 minutes) for various exemplary embodiments, at different ester quat fabric softening additive loading values. Data for a commercially available dryer sheet product is also shown, for comparison.

FIG. 8B is for the same test results shown in FIG. 8A, but shows the weight percent of lotion delivered at various treatment times (1 minute, 10 minutes, and 20 minutes) for various exemplary embodiments, at different ester quat fabric softening additive loading values. Data for a commercially available dryer sheet product is also shown, for comparison.

FIG. 9A shows grams of lotion delivered at various treatment times (1 minute, 10 minutes, and 20 minutes) for various exemplary embodiments, at different ester quat fabric softening additive loading values, at different treatment temperatures (70° F., 120° F., 135° F., and 150° F.). Data for a commercially available dryer sheet product is also shown, for comparison. The data of FIG. 9 is for the same test results as shown in FIG. 8A, but in FIG. 9, is broken down for the different tested treatment temperatures.

FIG. 9B is for the same test results shown in FIG. 9A, but shows the weight percent of lotion delivered at various treatment times (1 minute, 10 minutes, and 20 minutes) for various exemplary embodiments, at different ester quat fabric softening additive loading values, at different treatment temperatures. Data for a commercially available dryer sheet product is also shown, for comparison.

FIG. 10A shows grams of lotion delivered at various treatment times (1 minute, 10 minutes, and 20 minutes) for various exemplary embodiments, at different viscosity values.

FIG. 10B is for the same test results shown in FIG. 10A, but shows the weight percent of lotion delivered at various treatment times (1 minute, 10 minutes, and 20 minutes) for the various tested exemplary embodiments, at different viscosity values.

FIG. 10C shows weight percent of lotion delivered at various treatment times (1 minute, 10 minutes, and 20 minutes) for various exemplary embodiments, at different viscosity values, additionally broken down for different ester quat fabric softening additive loading values.

FIG. 11A shows viscosity data for the various exemplary embodiments of FIGS. 10A-10C, showing increased viscosity and more pronounced shear thinning with increased fabric softening additive.

FIG. 11B shows viscosity data for the various exemplary embodiments of FIGS. 10A-10C, showing increased viscosity with increasing actives content (fabric softening additive+surfactant). FIG. 11B also illustrates the shear thinning effects of higher actives loading.

### DETAILED DESCRIPTION OF THE PREFERRED EMBODIMENTS

### I. Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to a “surfactant” includes one, two or more surfactants.

Unless otherwise stated, all percentages, ratios, parts, and amounts used and described herein are by weight.

Numbers, percentages, ratios, or other values stated herein may include that value, and also other values that are about or approximately the stated value, as would be appreciated by one of ordinary skill in the art. As such, all values herein are understood to be modified by the term “about”. Such values thus include an amount or state close to the stated amount or state that still performs a desired function or achieves a desired result. A stated value should therefore be interpreted broadly enough to encompass values that are at least close enough to the stated value to perform a desired function or achieve a desired result, and/or values that round to the stated value. The stated values include at least the variation to be expected in a typical manufacturing or other process, and may include values that are within 10%, within 5%, within 1%, etc. of a stated value.

Some ranges may be disclosed herein. Additional ranges may be defined between any values disclosed herein as being exemplary of a particular parameter. All such ranges are contemplated and within the scope of the present disclosure.

As used herein, the term “between” is inclusive of any endpoints noted relative to a described range.

In the application, effective amounts are generally those amounts listed as the ranges or levels of ingredients in the descriptions, which follow hereto. Unless otherwise stated, amounts listed in percentage (“%'s”) are in weight percent (based on 100% active) of any composition.

The phrase ‘free of’ or similar phrases if used herein means that the composition or article comprises 0% of the stated component, that is, the component has not been intentionally added. However, it will be appreciated that such components may incidentally form thereafter, under some circumstances, or such component may be incidentally present, e.g., as an incidental contaminant.

The phrase ‘substantially free of’ or similar phrases as used herein means that the composition or article preferably comprises 0% of the stated component, although it will be appreciated that very small concentrations may possibly be present, e.g., through incidental formation, contamination, or even by intentional addition. Such components may be present, if at all, in amounts of less than 1%, less than 0.5%, less than 0.25%, less than 0.1%, less than 0.05%, less than 0.01%, less than 0.005%, less than 0.001%, or less than 0.0001%. In some embodiments, the compositions or articles described herein may be free or substantially free from any specific components not mentioned within this specification.

As used herein, “disposable” is used in its ordinary sense to mean an article that is disposed or discarded after a limited number of usage events, preferably less than 25, more preferably less than about 10, and most preferably after a single usage event. In an embodiment, substrates contemplated for use herein, whereon the dryer refresh composition is dosed are disposable.

As used herein, the term “substrate” is intended to include any material on which the dryer refresh composition is dosed, or otherwise stored or provided. Examples of substrates include, but are not limited to, a structure containing fiber materials, a knit article, a woven article, a nonwoven article, a sponge, a pad, a sheet, a foam, a cloth, or nonwoven wipes on which the composition may be dosed. In an embodiment, the substrate may be in the form of a wipe, tossed into the dryer with the load of fabric articles to be refreshed.

Some such substrates may be formed of a structure of individual fibers which are interlaid, typically in a manner that is not identifiable (e.g., a nonwoven). The nonwoven substrates, or layers used to make up such a nonwoven substrate included in the present substrates may be formed by any suitable process. For example, they may be meltblown, spunbond, spunlaid, SMS (spunbond-meltblown-spunbond), coformed, carded webs, thermal bonded, thermoformed, spunlace, hydroentangled, hydroembossed, needled, or chemically bonded. Various processes for forming such nonwovens will be apparent to those of skill in the art, many of which are described in U.S. Pat. No. 7,696,109, incorporated herein by reference in its entirety. EP Applications EP992338, EP1687136, EP1861529, EP1303661, and US2004/0157524 are also herein incorporated by reference, each in its entirety. These references describe various nonwoven structures which are generally illustrative, and which may be modified by using the contemplated plant-based renewable biodegradable and/or compostable fibers described herein rather than the synthetics typically employed in the prior art. Where the employed fibers are not thermoplastic (e.g., various pulp or cellulose derivatives), the processes used to form the nonwoven may of course not rely on melt-softening or thermoplasticity. Spunlace and hydroentangling are non-limiting examples of such processes. In an embodiment, the substrate may comprise polyethylene terephthalate (PET). In another embodiment the substrate may comprise a regenerated cellulose, such as lyocell. Combinations of various different fiber types may be employed.

The terms “wipe”, “substrate” and the like may thus overlap in meaning, and while “wipe” may typically be used herein for convenience, it will be appreciated that this term may often be interchangeable with “substrate”.

The compositions dosed onto the substrate as described herein may provide a refreshment or other benefit. Sanitization or disinfection are not required, although such may be provided, e.g., where an antimicrobial agent is included in the refresh composition.

In reference to various standardized tests it will be understood that reference to any such standard refers to the latest update (if any) to such standard, unless otherwise indicated. Any such referenced standards are incorporated herein by reference, in their entirety. Examples of such standardized tests include but are not limited to the Bovine Corneal Opacity and Permeability Assay (e.g., BCOP, OECD 437) and the Skin Corrosion Test (e.g., OECD 431). Such standardized tests will be familiar to those of skill in the art.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

### II. Introduction

In an embodiment, the present invention is directed to methods for providing a refresh treatment for fabric articles within a dryer (i.e., a fabric article drying appliance). The term “dryer” may be used herein for convenience. Such methods may include providing a dryer refresh composition that may include a fabric softener additive and/or a surfactant. Other adjuncts may also be present. In an embodiment, the composition may include from about 0.5% to about 25%, about 0.5% to about 20%, about 0.5% to about 15%, about 0.5% to about 10% or about 0.5% to about 5% by weight of the fabric softener additive, and/or from about 0.01% to about 15%, about 0.01% to about 10%, or about 0.01% to about 5% by weight of a surfactant. The method further includes placing the dryer refresh composition into the dryer with one or more fabric articles, in order to refresh such fabric articles. In particular, the fabric articles may actually already be dry, or substantially dry (i.e., they were not just removed from the washing machine after the spin cycle). Such a method allows a user to quickly refresh a given clothing or other fabric article without having to run the article through a full laundry cycle (wash and dry). In other words, according to the present method, already dry fabric articles could be placed in the dryer and run through a short dryer refresh cycle with the dryer refresh composition, even though no further drying of the fabric articles is desired to be achieved.

In contrast to the disclosure of US 2009/0193593, in an embodiment, the composition may be free or substantially free of cyclodextrins, water soluble polyionic polymers, pH adjusting mineral salts, zeolites, activated carbon, or other deodorizer agents. In an embodiment the composition may be free or substantially free of lower alcohols (e.g., ethanol, propanol, isopropanol, etc.), as such materials present safety challenges during manufacturing, and result in undesirable VOC emissions. The composition may similarly be free of diols (e.g., alkanediols). Furthermore, in an embodiment, the present compositions may be free or substantially free of waxes and similar hydrophobic and/or fabric softener components that are dry solids at room temperature, routinely provided in a dryer sheet. Where the dryer refresh composition is provided pre-dosed on a wipe or similar substrate, such wipe may be wet to the touch, dosed with the dryer refresh composition which is in liquid aqueous form.

### III. Dryer Refresh Compositions

### A. Fabric Softener Additives

Examples of fabric softener additives include ester quats or other cationic fabric softener additives (e.g., other quaternary ammonium fabric softener additives), phosphate ester anionic fabric softener additives or other anionic fabric softener additives, as well as fatty acid fabric softener additives or other non-ionic fabric softener additives.

A variety of ester quats or other fabric softener additives may be suitable for use in the present dryer refresh compositions for use with a dryer (whether or not heat is actually provided) to provide a refresh treatment to fabric articles (e.g., clothing, linens, towels, bedding, and other fabric articles) that may only be lightly soiled, if at all. For example, users may wish to treat fabric articles using such a treatment where such articles are clothing or other articles that have been worn or otherwise used once or only a few times, with little to no soil (e.g., a user's “floordrobe” or “chairdrobe”—where such items are on the floor or placed on a chair or the like). It would be desirable to refresh such articles, without requiring an entire and normally employed wash and dry cycle. The composition may comprise a fabric softener additive, an example of which is an ester quat, such as any quaternary amine compound that also includes an ester group, such as commonly employed in fabric softening applications. An exemplary compound may be a dialkyl ester ammonium methosulfate (also referred to as a dialkyl ammonium methosulfate). An example of such is shown below.

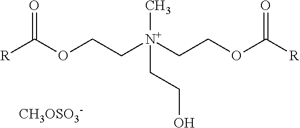

Such an ester quat may have a structure in which the quaternary nitrogen is bound to a methyl group. Other short chain alkyl groups may also be possible (e.g., C1-C4). The quaternary nitrogen may also be bound to a short chain alkanol group, e.g., ethanol, methanol, propanol, isopropanol, or the like. The illustrated R groups may independently represent any desired alkyl or alkene group, e.g., having from 12 to 20, or from 14 to 18, or from 16 to 18 carbon atoms. Functional groups other than alkyl or alkene groups are also possible. In an embodiment, the ester quat may be derived from or based on canola fatty acid.

Another example of a fabric softener additive is a phosphate ester, such as an ethoxylated phosphate ester. Poly(oxy-1,2-ethanediol)-hydro-hydroxy, mono C₁₇ branched alkyl ether, phosphate, also known as N-octyl polyethyleneglycol ether phosphate is a non-limiting example of such. Additional examples include similar compounds, but in which the octyl group has been replaced with another alkyl group (e.g., C₁₀, C₁₂, or other C₄ to C₃₀, C₆ to C₂₀, or C₆ to C₁₆ alkyl group).

While phosphate esters can conceivably be used, in some embodiments, it may be preferable to avoid components that include a phosphate group.

Another example of a fabric softener additive is a fatty acid and/or fatty alcohol. Examples of such may include fatty acids and/or fatty alcohols having from 8 to 30, or from 12 to 30 carbon atoms, such as from 16 to 20, or 16 to 18 carbon atoms. Examples include, but are not limited to 9-octadecanoic acid (e.g., oleic acid), cis-9-octadecen-1-ol (oleyl alcohol), C18, octadecan-1-ol (stearyl alcohol), and 1-dodecanol (lauryl alcohol).

In an embodiment, any of such fabric softener additives may be present in an amount of from about 0.5% to about 25%, about 0.5% to about 20%, about 0.5% to about 15%, about 0.5% to about 10%, about 0.5% to about 5%, or from about 1% to about 3%, or about 1.5% to about 2% by weight of the refresh composition.

The formulation can be dosed onto a wipe, or otherwise provided on a substrate (e.g., pad, sheet, cloth or the like) that can be added to a dryer, with fabric articles to be refreshed. In an embodiment, such fabric articles may already be substantially dry (they are not being loaded into the dryer for drying).

By way of example, in an embodiment, the composition is an aqueous composition, including at least about 30%, at least about 40%, at least about 50%, at least about 60%, at least about 70%, at least about 80%, at least about 85%, at least about 90%, at least about 92%, at least about 93%, at least about 94%, or at least about 95% water by weight. The composition may be aqueous in nature, and may be free or substantially free of waxes and similar hydrophobic and/or fabric softener components that are dry solids at room temperature, typically included in a substantially solid fabric softener composition. The composition can be a liquid, dosed onto the wipe or other substrate, so that the wipe or other substrate is wet to the touch, rather than the dry (or waxy) to the touch dryer sheets typically employed as fabric softeners, often added to a full dryer cycle.

Somewhat similar compositions, but which are specifically configured to provide a sanitizing or antimicrobial benefit, are described in Applicant's U.S. patent application Ser. No. 18/399,180 filed Dec. 28, 2023, which application is herein incorporated by reference in its entirety. By way of example and not limitation, the present refresh compositions may include any of the components described therein, and/or may be void of the various components described as void (or present) in such compositions.

### B. Solvents or Diluents

In an embodiment, the composition may be free of solvents or diluents other than water. If included, other solvents may be present in a small amount, or be absent, or substantially absent, as noted above. Examples of such solvents include but are not limited to glycol ether solvents such as ethylene glycol monopropyl ether, ethylene glycol monobutyl ether, ethylene glycol monohexyl ether, ethylene glycol phenyl ether, propylene glycol n-propyl ether, propylene glycol monobutyl ether, propylene glycol t-butyl ether, diethylene glycol monoethyl or monopropyl or monobutyl ether, di- or tri-polypropylene glycol methyl or ethyl or propyl or butyl ether, acetate and/or propionate esters of glycol ethers. Glycol and other solvents could alternatively be used. While some embodiments may include lower alcohol solvents (e.g., C₁-C₄ alcohols), the amount of such volatile solvents may be limited, e.g., to less than 10%, less than 5%, less than 3%, less than 2%, less than 1%, less than 0.5%, less than 0.4%, or less than 0.3% by weight. In some embodiments, the composition may be free of, or substantially free of, such lower alcohol or other highly volatile solvents. In an embodiment, the composition may similarly be free of diols (e.g., alkane diols). If a solvent other than water is present, such may be included from 0.1%, from 0.25%, up to 5%, up to 4%, up to 3%, up to 2%, or up to 1% by weight of the composition.

### C. Surfactants

Those of skill in the art will appreciate that any among a wide variety of surfactants (e.g., nonionic, zwitterionic or amphoteric, and/or cationic) may be included in the composition, as desired. Where an ester quat or similar cationic fabric softener additive is used, it may be desirable to exclude or substantially exclude anionic surfactants. Similarly, if an anionic fabric softener additive is used (e.g., a phosphate ester), cationic surfactants may be excluded or substantially excluded. A surfactant may be present from about 0.05%, from about 0.1%, up to about 15%, up to about 10%, up to about 5%, up to about 4%, up to about 3%, up to about 2%, or up to about 1% by weight of the composition. More typically, the surfactant concentration may range from about 0.1% to about 2% by weight, or from 0.3% to about 1% by weight. Various surfactants and other optional adjuncts are disclosed in U.S. Pat. No. 3,929,678 to Laughlin and Heuring, U.S. Pat. No. 4,259,217 to Murphy, U.S. Pat. No. 5,776,872 to Giret et al.; U.S. Pat. No. 5,883,059 to Furman et al.; U.S. Pat. No. 5,883,062 to Addison et al.; U.S. Pat. No. 5,906,973 to Ouzounis et al.; U.S. Pat. No. 4,565,647 to Llenado, and U.S. Publication No. 2013/0028990. The above patents and applications are each herein incorporated by reference in their entirety.

Examples of nonionic surfactants include, but are not limited to, alcohol ethoxylates (e.g., secondary alcohol ethoxylates), alcohol propoxylates, other alcohol alkoxylates including fatty (e.g., C₆, C₈, C₁₀, or C₁₂, or higher) alcohols or other constituents that have been alkoxylated to include both ethoxy and propoxy groups (EO-PO surfactants), alkyl phosphine oxides, alkyl glucosides and alkyl pentosides, alkyl glycerol esters, alkyl ethoxylates, and alkyl and alkyl phenol ethoxylates of all types, poly alkoxylated (e.g. ethoxylated or propoxylated) C₆-C₁₂ linear or branched alkyl phenols, C₆-C₂₂ linear or branched aliphatic primary or secondary alcohols, and C₂-C₈ linear or branched aliphatic glycols. Block or random copolymers of C₂-C6 linear or branched alkylene oxides may also be suitable nonionic surfactants. Capped nonionic surfactants in which the terminal hydroxyl group is replaced by halide; C₁-C₈ linear, branched or cyclic aliphatic ether; C₁-C₈ linear, branched or cyclic aliphatic ester; phenyl, benzyl or C₁-C₄ alkyl aryl ether; or phenyl, benzyl or C₁-C₄ alkyl aryl ester may also be used. Sorbitan esters and ethoxylated sorbitan esters may also be useful nonionic surfactants. Other suitable nonionic surfactants may include mono or polyalkoxylated amides of the formula R¹CONR²R³ and amines of the formula R¹NR²R³ wherein R¹ is a C₅-C₃₁ linear or branched alkyl group and R² and R³ are C₁-C₄ alkyl, C₁-C₄ hydroxyalkyl, or alkoxylated with 1-3 moles of linear or branched alkylene oxides. Biosoft 91-6 (Stepan Co.) is an example of an alkyl ethoxylate (or alcohol ethoxylate) having a methylene chain length of C₉ to C₁₁ with an average of 6 moles of ethoxylation. An example of an alcohol ethoxylate is ECOSURF EH-9, which is more specifically an ethylene oxide-propylene oxide copolymer mono(2-ethylhexyl) ether, available from Sigma-Aldrich.

Alkylpolysaccharide nonionic surfactants are disclosed in U.S. Pat. No. 4,565,647 to Llenado, having a linear or branched alkyl, alkylphenyl, hydroxyalkyl, or hydroxyalkylphenyl group containing from 6 to 30 carbon atoms and a polysaccharide, e.g., a polyglycoside, hydrophilic group containing from 1.3 to 10 saccharide units. Suitable saccharides may include, but are not limited to, glucosides, galactosides, lactosides, and fructosides. Alkylpolyglycosides may have the formula: R²O(CnH₂ₙO)ₜ(glycosyl)ₓ wherein R² is selected from the group consisting of alkyl, alkylphenyl, hydroxyalkyl, hydroxyalkylphenyl, and mixtures thereof in which the alkyl groups contain from 10 to 18 carbon atoms; n is 2 or 3; t is from 0 to 10, and x is from 1.3 to 10.

Fatty acid saccharide esters and alkoxylated fatty acid saccharide esters may also be suitable for use in the present invention. Examples include, but are not limited to, sucrose esters, such as sucrose cocoate, and sorbitan esters, such as polyoxyethylene (20) sorbitan monooleate and polyoxyethylene(20) sorbitan monolaurate.

Phosphate ester surfactants may also be suitable for use as surfactants, in addition to use as a fabric softener additive. These include mono, di, and tri esters of phosphoric acid with C₄-C₁₈ alkyl, aryl, alkylaryl, alkyl ether, aryl ether and alkylaryl ether alcohols (e.g. disodium octyl phosphate).

Zwitterionic surfactants may be suitable. As zwitterionic surfactants include both a positive and negative functional group, they may also be classified as nonionic surfactants. Many such zwitterionic surfactants contain nitrogen. Examples of such include amine oxides, sarcosinates, taurates and betaines. Examples include C₈-C₁₈ alkyldimethyl amine oxides (e.g., octyldimethylamine oxide, lauryldimethylamine oxide (also known as lauramine oxide), and cetyldimethylamine oxide), C₄-C₁₆ dialkylmethylamine oxides (e.g. didecylmethylamine oxide), C₈-C₁₈ alkyl morpholine oxide (e.g. laurylmorpholine oxide), tetra-alkyl diamine dioxides (e.g. tetramethyl hexanane diamine dioxide, lauryl trimethyl propane diamine dioxide), C₈-C₁₈ alkyl betaines (e.g. decylbetaine and cetylbetaine), C₈-C₁₈ acyl sarcosinates (e.g. sodium lauroylsarcosinate), C₈-C₁₈ acyl C₁-C₆ alkyl taurates (e.g. sodium cocoylmethyltaurate), C₈-C₁₈ alkyliminodipropionates (e.g. sodium lauryliminodipropionate), and combinations thereof. Lauryl dimethyl amine oxide (Ammonyx LO) myristyl dimethyl amine oxide (Ammonyx MO), decylamine oxide (Ammonyx DO) are examples of suitable zwitterionic surfactants, available from Stepan Co.

Where a cationic ester quat or similar cationic fabric softener is included, anionic surfactants may be omitted. Non-limiting examples of anionic surfactants include alkyl sulfates (e.g., C₈-C₁₈ linear or branched alkyl sulfates such as sodium lauryl sulfate (SLS), and sodium tetradecylsulfate), alkyl sulfonates (e.g., C₆-C₁₈ linear or branched alkyl sulfonates such as sodium octane sulfonate) and secondary alkane sulfonates, alkyl ethoxysulfates, fatty acids and fatty acid salts (e.g., C₆-C₁₆ fatty acid soaps such as sodium laurate), and alkyl amino acid derivatives. Other examples may include sulfate derivatives of alkyl ethoxylate propoxylates, alkyl ethoxylate sulfates, alpha olefin sulfonates, C₆-C₁₆ acyl isethionates (e.g. sodium cocoyl isethionate), C₆-C₁₈ alkyl, aryl, or alkylaryl ether sulfates, C₆-C₁₈ alkyl, aryl, or alkylaryl ether methylsulfonates, C₆-C₁₈ alkyl, aryl, or alkylaryl ether carboxylates, sulfonated alkyldiphenyloxides (e.g. sodium dodecyldiphenyloxide disulfonate), and the like.

More specific examples of nonionic and/or zwitterionic surfactants include lauryl dimethyl amine oxide (Ammonyx LO), also known as lauramine oxide, myristyl dimethyl amine oxide (Ammonyx MO), decylamine oxide (Ammonyx DO), other amine oxides, any betaines, linear alcohol ethoxylates, secondary alcohol ethoxylates, alcohol propoxylates, alkyl polyglucosides, and combinations thereof. In an embodiment, any included surfactant may be limited to a nonionic, cationic or zwitterionic (also referred to as amphoteric) surfactants, particularly where a cationic fabric softener is employed.

### D. Additional Adjuncts

The composition may optionally include and/or be used in combination with one or more additional adjuncts. The adjuncts include, but are not limited to, fragrances or perfumes or essential oils, dyes and/or colorants, solubilizing materials, stabilizers, thickeners, defoamers, hydrotropes, buffers, builders, lotions and/or mineral oils, enzymes, cloud point modifiers, odor control additives, additional fabric softeners, antistatic agents, siloxanes, wrinkle release agents, allergen neutralization agents, antimicrobial actives, microbiostatic agents, skin-enhancing agents, allergen-free additives, fabric longevity enhancers, and/or preservatives. Any such additional adjuncts may be present in an amount of up to about 10%, up to about 5%, up to about 4%, up to about 3%, up to about 2%, up to about 1%, at least about 0.001%, at least about 0.01%, at least about 0.1%, or any ranges defined between such values, or other values described herein for specific adjuncts.

Various fragrances or perfumes or essential oils may be employed, e.g., in an amount ranging from greater than 0% to about 10%, or greater than 0% to about 5% (e.g., about 0.01% to about 4%, or about 0.5% to about 3% by weight. The term “fragrance” is used broadly, and encompasses perfumes and/or essential oils. As discussed herein, a greater variety of fragrances may be possible, as compared to alternative methods that do not limit the temperature within the dryer to no more than about 145° F., about 140° F., about 135° F., about 130° F., about 125° F. or about 120° F.

In one embodiment, buffering and pH adjusting agents, when used, include, but are not limited to, organic acids (e.g., citric acid), mineral acids, alkali metal and alkaline earth salts of citrate, silicate, metasilicate, polysilicate, borate, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and/or 2-amino-2methylpropanol.

A buffering agent can be a low molecular weight, organic or inorganic material used for maintaining the desired pH. The buffer can be alkaline, acidic or neutral. Non-limiting examples of buffering agents include nitrogen-containing materials (e.g., lysine; lower alcohol amines like mono-, di-, and tri-ethanolamine; tri (hydroxymethyl) amino methane; 2-amino-2-ethyl-1,3-propanediol; 2-amino-2-methyl-propanol; 2-amino-2-methyl-1,3-propanol; disodium glutamate; methyl diethanolamide; 2-dimethylamino-2-methylpropanol; 1,3-bis(methylamine)-cyclohexane; 1,3-diamino-propanol N,N′-tetra-methyl-1,3-diamino-2-propanol; N,N-bis(2-hydroxyethyl)glycine; tris(hydroxymethyl)methyl glycine; ammonium carbamate; citric acid; acetic acid; ammonia; alkali metal carbonates; and/or alkali metal phosphates). For additional buffers that can be used, see McCutcheon's EMULSIFIERS AND DETERGENTS, North American Edition, 1997, McCutcheon Division, MC Publishing Company which is incorporated herein by reference. In yet another and/or alternative embodiment, solubilizing materials, when used, can include, but are not limited to, hydrotropes (e.g., water soluble salts of low molecular weight organic acids such as the sodium and/or potassium salts of xylene sulfonic acid). In another and/or alternative embodiment, the acids, when used, include, but are not limited to, organic hydroxy acids, citric acids, keto acid, and the like.

In still another and/or alternative embodiment, thickeners, when used, include, but are not limited to, polyacrylic acid, xanthan gum, calcium carbonate, aluminum oxide, alginates, guar gum, methyl celluloses, ethyl celluloses, clays, and/or propylhydroxycelluloses. In yet another and/or alternative embodiment, defoamers, when used, include, but are not limited to, silicones, aminosilicones, silicone blends, and/or silicone/hydrocarbon blends. In still a further and/or alternative embodiment, preservatives, when used, include, but are not limited to, mildewstats or bacteriostats, methyl, ethyl and propyl parabens, short chain organic acids (e.g., acetic, lactic and/or glycolic acids), bisguanidine compounds (e.g., Dantagard and/or Glydant) and/or short chain alcohols (e.g., ethanol and/or IPA). In one aspect of this embodiment, the mildewstats or bacteriostats include, but are not limited to, mildewstats (including non-isothiazolone compounds) include Kathon GC, a 5-chloro-2-methyl-4-isothiazolin-3-one, Kathon ICP, a 2-methyl-4-isothiazolin-3-one, and a blend thereof, and Kathon 886, a 5-chloro-2-methyl-4-isothiazolin-3-one, all available from Rohm and Haas Company; Bronopol, a 2-bromo-2-nitropropane-1,3-diol, from Boots Company Ltd.; Proxel CRL, a propyl-p-hydroxybenzoate, from ICI PLC; Nipasol M, an o-phenyl-phenol, Na+ salt, from Nipa Laboratories Ltd.; Dowicide A, a 1,2-Benzoisothiazolin-3-one, from Dow Chemical Co.; and Irgasan DP 200, a 2,4,4′-trichloro-2-hydroxydiphenylether, from Ciba-Geigy A.G.

Examples of allergen neutralizing agents are described in Applicant's application Ser. Nos. 18/782,421 and 63/515,677 filed Jul. 24, 2024 and Jul. 26, 2023 respectively, both entitled “SYSTEMS AND METHODS FOR NEUTRALIZATION OF AIRBORNE ALLERGENS WITH ORGANIC ACIDS”, each of which is herein incorporated by reference in its entirety.

In example embodiments, the organic acid allergen neutralizing agent is a short chain organic acid, e.g., having no more than 12, no more than 10, no more than 8, or no more than 6 carbon atoms. The organic acid can be a mono-organic acid, a dicarboxylic, or a polycarboxylic acid. Some further non-limiting examples of organic acids that can be used as allergen neutralizing agents in the formulations described herein include alpha hydroxy acids, fatty acids, keto acids, dicarboxylic acids, unsaturated carboxylic acids, alkane sulfonic acids, and aromatic acids. An example organic acid that is effective for use as the allergen neutralizing agents in the formulations described herein (e.g., meets appropriate vapor pressure and aqueous solubility requirements at room temperature and standard pressure) is lactic acid. A non-limiting group of organic acids that can be useful as active ingredients in formulations described herein (having suitable vapor pressures and aqueous solubilities at room temperature and standard pressure) includes lactic acid, glycolic acid, butyric acid, pyruvic acid, maleic acid, and methane sulfonic acid. Formulations can include one or more of such organic acids and any combinations or mixtures thereof.

Each organic acid of interest (e.g., satisfying appropriate vapor pressure and aqueous solubility requirements as described in the above referenced application) can be provided in an effective amount within a formulation to provide a sufficient neutralization of airborne allergens. For example, each organic acid can be included in the formulations described herein in an amount from about 0.05%, from about 0.1%, from about 0.2%, from about 0.5%, from about 1%, from about 1.5%, from about 2%, up to about 20%, up to about 15%, up to about 10%, up to about 8%, up to about 6%, up to about 5%, up to about 4%, or up to about 3% by weight of the formulation. In a further example, an effective amount of an organic acid (e.g., lactic acid) in the formulation can range from about 0.1% to about 20% by weight of the formulation, or from about 0.2% to about 20% by weight of the formulation. In a still further example, an effective amount of an organic acid in the formulation can range from about 0.1% to about 5% by weight of the formulation, from about 1% to about 5% by weight of the formulation, from about 1% to about 4.5% by weight of the formulation, or from about 1% to about 4.3% by weight of the formulation. In a specific example, lactic acid can be provided in a formulation in an effective amount of about 2% by weight of the formulation.

In some example embodiments of formulations including an allergen neutralizing agent, the pH of the formulations can be kept low. A low pH can enhance the organic acid efficacy (e.g., lactic acid efficacy) in neutralization of airborne allergens. Typically, pH is kept a least 1 unit below pKa of the organic acid to ensure the majority (e.g., at least 90%) of acid stays in the active (conjugate acid) form. For example, lactic acid is most efficacious in the acid form compared to the conjugate base form (lactate salts), since the acid form of lactic acid is more volatile. At a pH of 2.2, at least 95% of present lactic acid is in the acidic form (lactic acid has a pKa of 3.79). While lactic acid has higher efficacy at low pH, a more neutral pH formulation has better aesthetics and potentially lower toxicity. Therefore, a pH that provides a balance between efficacy of lactic acid with regard to neutralization of airborne allergens and aesthetics and toxicity levels is desirable, where an allergen neutralization agent is included.

By way of example, the pH can be at least about 1, at least about 1.5, at least about 2, up to about 6.5, up to about 6, up to 5, up to about 4, up to about 3, up to about 2, up to about 2.5, or up to about 2.4. In example embodiments, the pH can be maintained between about 2 and about 4, or about 2 and about 3. The pH can be maintained, e.g., by the addition of a buffer such as citric acid or another suitable buffer including but not limited to: acids, bases, carbonates, bicarbonates, etc. However, it is important to note that the citric acid (when provided in formulations) may be present as a buffer, rather than for any providing any primary allergen neutralization benefit in airborne environments. Any citric acid buffer can be included in an amount of at least about 0.05%, at least about 0.1%, up to about 6%, up to about 5%, up to about 4%, up to about 3%, up to about 2%, up to about 1.5%, or up to about 1% by weight of formulation including an allergen neutralizing agent.

Several non-limiting examples of organic acids that could be used as allergen neutralizing agents are shown in Table 1 below.

TABLE 1

| | | | | Suitable |
|---|---|---|---|---|
| | | | Solubility | for anti- |
| | | | in water | allergen |
| | | | (g of | formulation |
| | | | compound | (meets vapor |
| | | Vapor | in 100 g | pressure and |
| | Organic | Pressure | of water | solubility |
| Category | Acid | (Pa) | at ~20° C.) | criteria) |
| alpha | lactic acid | 10.00 | Miscible | Y |
| hydroxy | | | | |
| acid | | | | |
| | glycolic acid | 0.41 | 30 | Y |
| | citric acid | 0.000002 | 59.2 | N |
| fatty acid | acetic acid | 2080 | 60.29 | N |
| | propionic | 390 | 100 | N |
| | acid | | | |
| | butyric acid | 100 | Very | Y |
| | | | soluble | |
| | valeric acid | 100 | 3.75 | N |
| | hexanoic | 5.80 | 1.03 | N |
| | acid | | | |
| | heptanoic | 1.35 | 0.2 | N |
| | acid | | | |
| | octanoic acid | 0.49 | 0.068 | N |
| Alkane | methane | 0.048 | 100 | Y |
| sulfonic | sulfonic acid | | | |
| acid | | | | |
| keto acid | levulinic acid | 0.374 | 79.13 | Y |
| | pyruvic acid | 172 | 100 | Y |
| dicarboxylic | adipic acid | 9.70 | 23 | Y |
| acid | | | | |
| | malonic acid | 0.00049 | 76.3 | N |
| unsaturated | fumaric acid | 0.02 | 0.7 | N |
| carboxylic | | | | |
| acid | | | | |
| | maleic acid | 0.001 | 47.88 | Y |
| | malic acid | 0.000004 | 64.7 | N |
| | sorbic acid | 0.018 | 0.156 | N |
| aromatic | benzoic acid | 0.11 | 0.35 | N |
| acid | | | | |
| amino acid | glycine | 0.000017 | 24.99 | N |

In an embodiment, because the refresh composition is employed at a relatively low temperature (e.g., no greater than about 145° F., 140° F., 135° F. or 120° F.), the refresh composition can include components that are currently not included within various dryer sheet products or similar products intended for addition to a dryer, because of their loss of functionality at typical elevated temperatures associated with typical dryer use. For example, the composition can include a fragrance, enzyme, probiotic or other component that would exhibit a loss of functional properties at temperatures greater than about 145° F., 135° F. or 120° F. By way of example, there are various fragrance compositions that could be employed with the present refresh compositions employed at relatively moderate temperature, where at higher temperatures such fragrance materials may lose some “high note” portions of the fragrance, e.g., due to volatility of such components at elevated temperature. Similarly, various enzymes, probiotics, and similar components may be deactivated at higher temperatures, but so long as the temperature is maintained at lower than about 120° F., or lower than about 110° F., such may not be an issue. The present embodiments thus allow incorporation of various desirable adjuncts to the refresh composition, where such incorporation would not otherwise be possible, because the method of use limits the temperature, to preserve the functional benefits provided by such adjuncts.

Another advantage provided by ensuring that the treatment temperature is limited is to ensure that any soiling or stains present in the fabric articles being treated are not heat set. This can be particularly important as the present method does not contemplate a wash cycle preceding the refresh treatment. It is important to ensure that any soiling or stains present in the fabric articles be removable within the next wash cycle.

### E. Other Characteristics

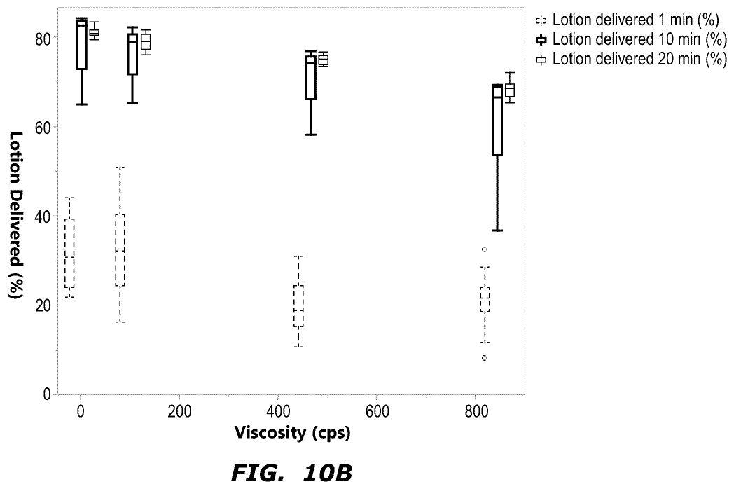

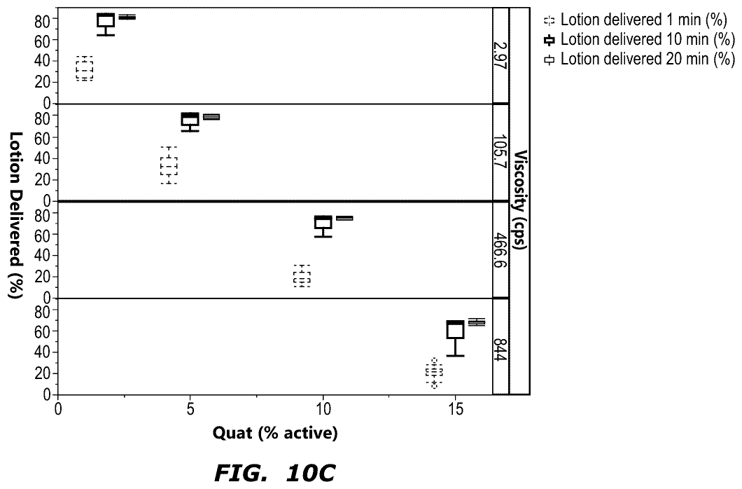

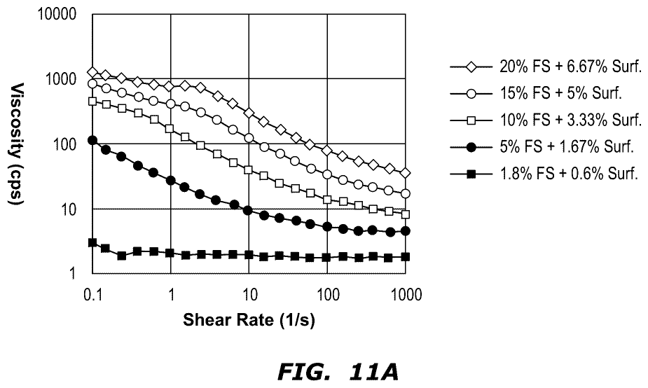

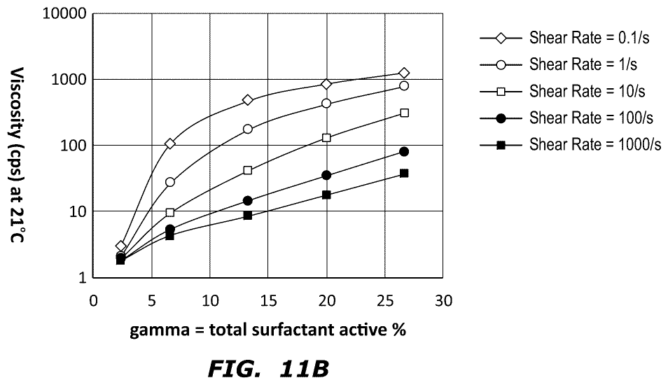

In an embodiment, the composition may have a relatively low viscosity, e.g., less than about 1000 cps, less than about 500 cps, or less than about 100 cps (e.g., from about 0.01 cps to about 100 cps, or from about 1 cps to about 100 cps). In an embodiment, the viscosity may range from about 0.05 cps to about 1300 cps. Alternatively, the composition may be thickened, so as to have a higher viscosity (e.g., greater than 1000 cps, greater than 5000 cps, or greater than 10,000 cps). Such viscosity values may be measured at 20° C., and at a shear rate of 0.1 s⁻¹, 1 s⁻¹, 10 s⁻¹, 100 s⁻¹, and/or 1000 s⁻¹. The composition may be shear thinning, with reduced viscosity at higher shear rates, e.g., as apparent from the data corresponding to that in FIGS. 10A-10C and 11A-11B. The shear thinning characteristics may be more pronounced at higher actives loading (e.g., higher loading of the fabric softening additive and/or surfactant(s)).

In an embodiment, the composition may have a pH ranging from about 2 to about 11, about 2 to about 9, about 2 to about 6, such as from about 2 to about 4.

Examples of additional possible adjuncts may be found in U.S. Pat. Nos. 6,825,158; 8,648,027; 9,006,165; 9,234,165; 9,988,594; 10,421,929 and U.S. Publication No. 2008/003906, each of which is herein incorporated by reference in its entirety.

Additional adjuncts are disclosed in U.S. Pat. No. 5,460,833 to Andrews et al.; U.S. Pat. No. 6,221,823 to Crisanti; U.S. Pat. No. 6,346,279 to Rochon et al.; U.S. Pat. No. 6,551,980 to Wisniewski et al.; U.S. Pat. No. 6,699,825 to Rees et al.; U.S. Pat. No. 6,803,057 to Ramirez et al.; U.S. Pat. No. 6,812,196 to Rees et al.; U.S. Pat. No. 6,936,597 to Urban; U.S. Pat. No. 7,008,600 to Katsigras et al.; U.S. Pat. No. 7,070,737 to Bains et al.; U.S. Pat. No. 7,354,604 to Ramirez et al.; U.S. Pat. No. 7,598,214 to Cusack et al.; U.S. Pat. No. 7,605,096 to Tamarchio et al.; U.S. Pat. No. 7,658,953 to Bobbert; U.S. Pat. No. 7,696,143 to McCue et al.; U.S. Pat. No. 7,915,207 to Chopskie et al.; U.S. Pat. No. 8,569,220 to Gaudrealt; U.S. Pat. No. 8,575,084 to Gaudrealt; U.S. Pat. No. 10,064,409 to Hazenkamp et al.; U.S. Pat. No. 10,076,115 to Salminen et al.; U.S. Pat. No. 10,358,624 to Mitchell et al.; U.S. Publication No. 2007/0190172 to Bobbert; PCT Publication Nos. WO 99/18180 to Raso et al.; WO 99/53006 to Masotti et al.; WO 2004/067194 to Arrigoni et al.; WO 2004/104147 to Rosiello et al.; WO 2017/174959 to Convery; and EPO Publication EP 2843034 to Nedic et al., each of which is herein incorporated by reference in its entirety.

In some embodiments, it may be possible to provide a wipe or other substrate for delivery of the dryer refresh composition. In an embodiment, such substrate could be provided in “dry” form, where dosing or loading with the refresh composition may occur after manufacture (e.g., by the user). That said, pre-dosing or loading of the substrate during manufacture may be preferred, e.g., as the amount and concentrations of the components in the composition, and the loading ratio of such composition relative to the substrate can be more carefully controlled during manufacture, than may occur where the final composition may depend on the user following provided instructions.

With regard to pre-moistened substrates, a selected amount of liquid may be added to the container of such substrates during manufacture such that the substrates contain the desired amount of liquid. The substrates are not necessarily loaded to their saturation point, but are typically loaded with the composition to some ratio less than full saturation. For example, many substrates are capable of holding about 8 to 14 times their weight in liquid. For various reasons, the substrates may be loaded at a loading ratio less than saturation, e.g., less than 10:1 or less than 9:1, at least 2:1, at least 2.5:1, at least 3:1, or at least 4:1 such as from 2.5:1 to 8.5:1, from 3:1 to 8:1, from 3:1 to 6:1 or from 6:1 to 8:1. Stated another way, the loading ratio may be from about 50% to about 100%, from about 60% to about 90%, from about 70% to about 80%, or from about 75% to about 80% of saturation.

It is important to understand and account for how the substrate materials affect the chemistry of the composition being dosed onto the substrate. For example, it can be important to avoid or minimize unwanted chemical interactions that may inadvertently deactivate the active agents within the composition. For example, incompatibility between components in the composition versus the substrate can occur, which would be undesirable, or at least must be accounted for. The composition that is released from the pre-loaded substrate can be referred to as “squozate” The term “squozate” is used as a holdover from cleaning wipes, even though the present substrates are typically not used to wipe a given surface, and the composition loaded therein is not typically squeezed from the wipe, but is simply tossed into the dryer, and run through a short dryer cycle with the fabric articles to be refreshed. When components of a composition react with or bind to a substrate, the composition that is loaded onto the substrate differs from the “squozate”. It is desirable that an effective amount of any given active agent not only be loaded into the substrate, but actually be released in the “squozate” from such substrate, during use.

The size and shape of the substrate can vary with respect to the intended application and/or end use of the same. The substrate can have a substantially rectangular shape of a size that allows it to readily be added to a dryer. In another embodiment, another shape, e.g., circular, oval, or the like) may be provided. In an embodiment, the loaded substrate may simply be tossed into the dryer with the load of fabric articles to be refreshed.

The substrates may be provided pre-moistened with a refresh composition. The wet substrates can be maintained over time in a scalable container such as, for example, within a bucket or tub with an attachable lid, scalable bags, plastic pouches (e.g., “flex packs”), canisters (e.g., with a roll of substrates positioned as a “donut” in the canister), jars, and so forth. Desirably the wet, stacked substrates are maintained in a resealable container, or packaged sealed as an individual dose use. The use of a resealable container is particularly desirable when using aqueous volatile liquid compositions since substantial amounts of water or other liquid can evaporate while using the first sheets thereby leaving the remaining sheets with little or no liquid. Of course where single sheets (or multiple sheets, if the directions call for multiple sheets introduced into the dryer) are sealed individually, no resealing is needed. Exemplary resealable containers and dispensers include, but are not limited to, those described in U.S. Pat. No. 4,171,047 to Doyle et al., U.S. Pat. No. 4,353,480 to McFadyen, U.S. Pat. No. 4,778,048 to Kaspar et al., U.S. Pat. No. 4,741,944 to Jackson et al., U.S. Pat. No. 5,595,786 to McBride et al.; the entire contents of each of the aforesaid references are incorporated herein by reference.

Typically, the refresh substrates are stacked or otherwise placed in the container and the liquid subsequently added thereto, all during mass manufacturing. No matter the packaging and dosing process, once manufactured and packaged, the substrate can subsequently be used by removing a number of desired substrates, and adding them to the dryer, with the load of fabric articles to be refreshed. In an embodiment, 1, or more than 1 such sheet or other substrate may be added to the load (e.g., from 1 to 5 sheets or other substrates) to provide the desired level of refreshment.

In an embodiment, each sheet or other substrate may be dosed with about 5 g to about 50 g, or from about 5 g to about 25 g of refresh composition.

The dryer may be run through a short dryer cycle at a given temperature, which may be elevated or not relative to ambient (e.g., about 70° F.) temperature. In an embodiment, such temperature may be no greater than about 145° F., about 140° F., about 135° F., about 130° F., about 125° F. or about 120° F., such as from about 70° F. to about 110° F., or from about 90° F. to about 110° F. or from about 70° F. to about 90° F. The duration of the refresh cycle within the dryer while the dryer drum rotates may be relatively short, shorter than a typical dryer cycle needed to dry fabric articles being dried immediately after a wash cycle. For example, such period of time may be no more than about 20 minutes, no more than about 15 minutes, no more than about 10 minutes, or no more than about 5 minutes, such as from about 1 minute to about 15 minutes, from about 1 minute to about 10 minutes, or from about 1 minute to about 5 minutes.

In one embodiment, a provided substrate (akin to a dryer sheet) may be from about 5½ inches to about 11 inches in length, and from about 5½ inches to about 11 inches in width. The tested substrates in the below described examples were about 6.75 inches by 9 inches. The substrate can have dimensions such that the length and width differ by no more than about 2 or 3 inches. Larger or smaller substrates are also possible. The substrates may be sufficiently thin to have a basis weight of no more than about 200 gsm, no more than about 150 gsm, no more than about 100 gsm, such as from about 5 to about 80 gsm, or from about 10 to about 60 gsm. The tested substrates in the below described examples had a basis weight of about 52 gsm.

### IV. Examples

Various exemplary formulations are shown in the Tables below.

TABLE 2

| Component | Function | Weight Percent |
|---|---|---|
| Water | Diluent | To 100% |
| Dialkyl ammonium | Fabric | 1-2.5% |
| methosulfate | Softener | |
| Alcohol Ethoxylate | Surfactant | 0.3-1% |
| Fragrance | Fragrance | Up to 2% |

TABLE 3

| Component | Function | Weight Percent |
|---|---|---|
| Water | Diluent | To 100% |
| Dialkyl ammonium | Fabric | 1.8% |
| methosulfate | Softener | |
| Alcohol Ethoxylate | Surfactant | 0.6% |
| Fragrance | Fragrance | Up to 2% |

TABLE 4

| Component | Function | Weight Percent |
|---|---|---|
| Water | Diluent | To 100% |
| Triethanolamine-based | Fabric | 1-2.5% |
| esterquat (TEAQ) | Softener | |
| Alcohol Ethoxylate | Surfactant | 0.3-1% |
| Fragrance | Fragrance | Up to 2% |

TABLE 5

| Component | Function | Weight Percent |
|---|---|---|
| Water | Diluent | To 100% |
| Diamidoamine tallow quat | Fabric Softener | 1-2.5% |
| Alcohol Ethoxylate | Surfactant | 0.3-1% |
| Fragrance | Fragrance | Up to 2% |

TABLE 6

| Component | Function | Weight Percent |
|---|---|---|
| Water | Diluent | To 100% |
| N-Octyl polyethyleneglycol | Fabric | 1-2.5% |
| ether phosphate | Softener | |
| Alcohol Ethoxylate | Surfactant | 0.3-1% |
| Fragrance | Fragrance | Up to 2% |

TABLE 7

| Component | Function | Weight Percent |
|---|---|---|
| Water | Diluent | To 100% |
| N-Decyl polyethyleneglycol | Fabric | 1-2.5% |
| ether phosphate | Softener | |
| Alcohol Ethoxylate | Surfactant | 0.3-1% |
| Fragrance | Fragrance | Up to 2% |

TABLE 8

| Component | Function | Weight Percent |
|---|---|---|
| Water | Diluent | To 100% |
| N-Lauryl polyethyleneglycol | Fabric | 1-2.5% |
| ether phosphate | Softener | |
| Alcohol Ethoxylate | Surfactant | 0.3-1% |
| Fragrance | Fragrance | Up to 2% |

TABLE 9

| Component | Function | Weight Percent |
|---|---|---|
| Water | Diluent | To 100% |
| 9-Octadecanoic Acid | Fabric | 2-4% |
| (oleic acid) | Softener | |
| Alcohol Ethoxylate | Surfactant | 0.3-1% |
| Fragrance | Fragrance | Up to 2% |

TABLE 10

| Component | Function | Weight Percent |
|---|---|---|
| Water | Diluent | To 100% |
| cis-9-Octadecen-1-ol | Fabric | 2-4% |
| (oleyl alcohol) | Softener | |
| Alcohol Ethoxylate | Surfactant | 0.3-1% |
| Fragrance | Fragrance | Up to 2% |

TABLE 11

| Component | Function | Weight Percent |
|---|---|---|
| Water | Diluent | To 100% |
| C18, Octadecan-1-ol | Fabric | 2-4% |
| (stearyl alcohol) | Softener | |
| Alcohol Ethoxylate | Surfactant | 0.3-1% |
| Fragrance | Fragrance | Up to 2% |

TABLE 12

| Component | Function | Weight Percent |
|---|---|---|
| Water | Diluent | To 100% |
| 1-Dodecanol | Fabric | 2-4% |
| (lauryl alcohol) | Softener | |
| Alcohol Ethoxylate | Surfactant | 0.3-1% |
| Fragrance | Fragrance | Up to 2% |

Testing was carried out to determine the effect of various factors on the ability of a given dosed wipe to quickly release the refresh composition. In an embodiment, it is advantageous to provide a configuration where at least 60%, at least 65%, at least 70%, at least 75%, or at least 80% of the dryer refresh composition releases from the wipe within about 20 minutes, within about 15 minutes, within about 10 minutes, or within about 5 minutes, at a temperature of no greater than about 145° F., about 140° F., about 135° F., about 130° F., about 125° F. or about 120° F.

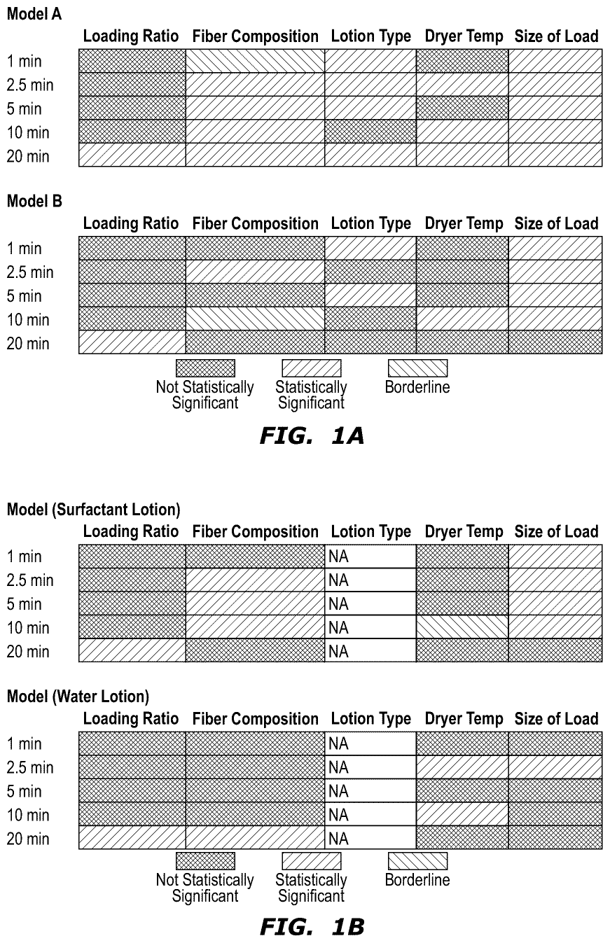

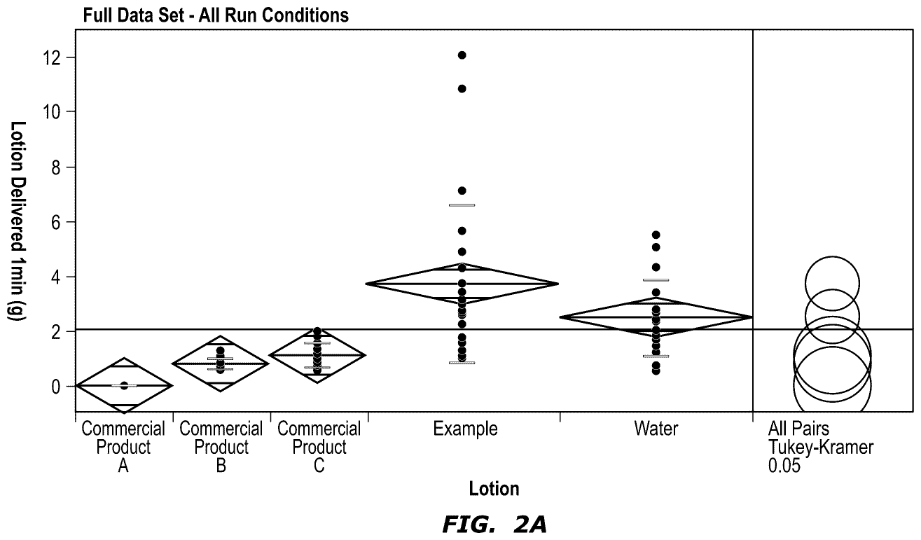

FIG. 1A shows the impact of various factors such as loading ratio, substrate fiber composition, lotion type, dryer temperature, and size of load on lotion release from an exemplary dosed wipe based on results from a design of experiments (DOE) study, and based on a model developed from actual test data. FIG. 1B shows similar results, but for compositions that include an exemplary lotion (e.g., with the fabric softener and surfactant additives), as compared to another composition that consists of only water. The results in FIGS. 1A-1B show that lotion release behavior is driven by various factors, depending on the dryer treatment time. The results shown are for a 95% confidence interval. Different factors drive the percentage of lotion released at different dryer treatment times, for the different tested lotion types. As is apparent, loading ratio does not exhibit much of an effect on lotion release, except at the 20 minute dryer treatment times, for the tested loading ratios. Tested loading ratios ranged from about 3 or 4 to about 8. From the tables, it can be seen what combinations of dryer treatment time and various factors significantly affected lotion release behavior. The tested fiber compositions included a polyethylene terephthalate (PET) nonwoven wipe as well as a lyocell nonwoven wipe. The tested lotion types included a lotion such as that shown in Tables 2-3, as compared to a lotion that consisted only of water. The tested dryer temperatures included a temperature of 70° F. (i.e., no heating) as compared to a dryer temperature of 120° F. The tested load sizes included a 1 lb load size as well as a 4 lb load size.

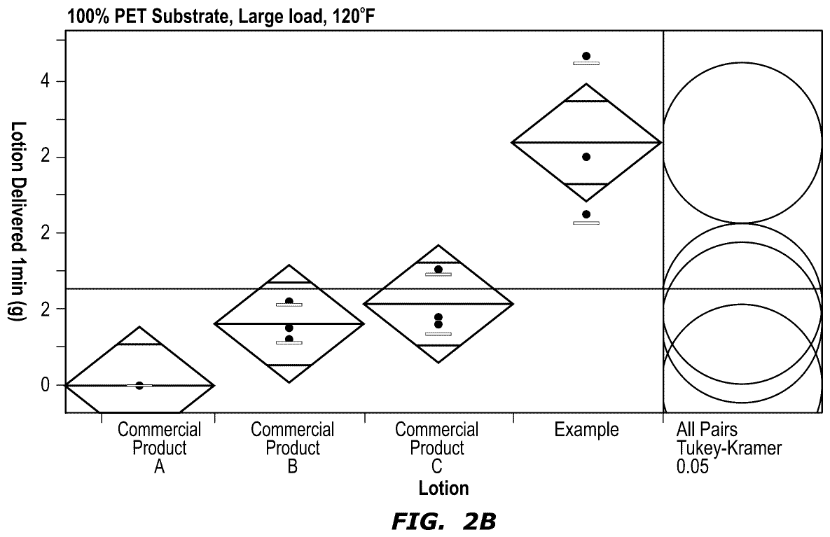

FIG. 2A shows grams of lotion released within the first minute of treatment for all collected data, across all tested conditions. In addition to testing both an example lotion formulation (e.g., similar to that shown in Tables 2 and 3) as compared to a lotion that consisted of only water, various commercially available dryer sheet products were also tested. The results show a significant difference in the grams of lotion released by the presently described dryer refresh compositions, as compared to a control that consists of water, and as compared to the tested commercially available dryer sheet products. For example, it was noted that the commercially available dryer sheet products include a waxy solid composition, which is not easily released from the dryer sheet at the desired relatively low treatment temperatures, but that significantly higher temperatures are required to release such compositions from the commercially available products. In addition, such existing dryer sheet products typically do not provide for more than about 5 g or 10 g of loaded lotion. The present embodiments can be loaded with a higher lotion loading (e.g., at least 10 g, such as from 10 g to about 25 g). In addition to providing a more rapid lotion release than the comparative products, the present embodiments also provide a greater overall lotion release (e.g., total grams of lotion released is significantly higher, representing typically 50-80% of the 5 g to 25 g, or 10 g to 25 g of the initial loading amount). In addition, it was noted that the contemplated compositions including the fabric softener additive and a surfactant exhibit a significantly higher release than when using water alone. The presence of such components aids in achieving a desired higher release of the lotion, even though the added components are generally not volatile. Such a result is somewhat surprising, and counterintuitive.

FIG. 2B shows grams of lotion released within the first minute of treatment at particular test conditions when using a polyethylene terephthalate (PET) wipe, at 120° F., with a 4 lb load.

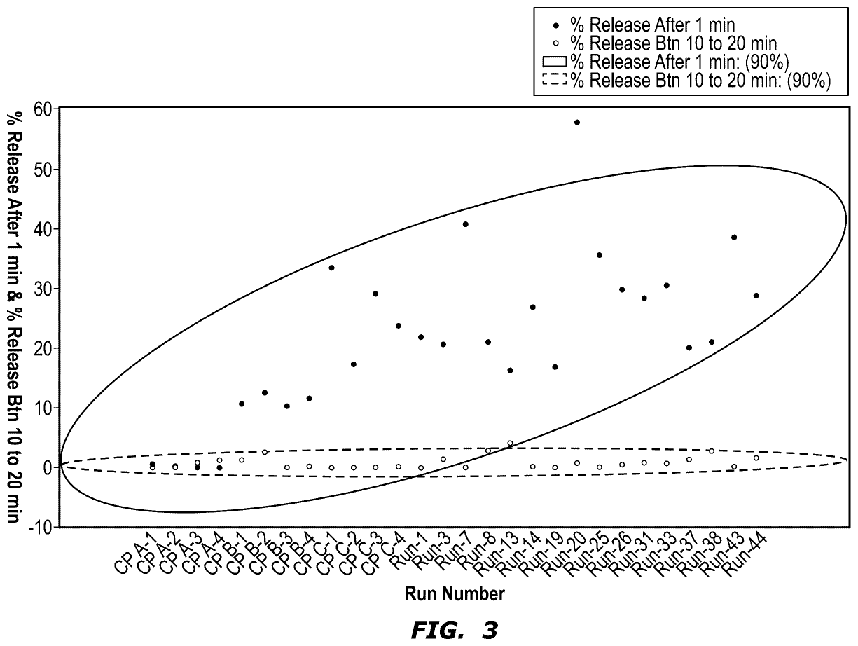

FIG. 3 shows percent lotion release after 1 minute, as well as percent lotion release between 10 minutes and 20 minutes, for various comparative and exemplary embodiments. The results show a significantly greater release within 1 minute for the example formulations, as compared to the various commercially available products. The illustrated significant difference in results is due to the structural differences in the tested products (e.g., lack of waxy components versus use of a liquid composition, etc.). As shown, the presently tested dosed substrates exhibit a quick release of the lotion within the wipe, e.g., releasing nearly all lotion that will be released, within the first 10 minutes of treatment. For example, the cumulative release after 10 minutes may be at least 70%, at least 80%, at least 90%, or at least 95% of the total amount that will be released (e.g., relative to the asymptote). It will be appreciated that some fraction of the lotion is never released, e.g., such that at least 60%, at least 70%, or at least 80% of the lotion dosed into the wipe may be released within such short time frame (e.g., within 20 minutes, within 15 minutes, within 10 minutes, or within 5 minutes). The remaining percentage of lotion that is not released, may never be released, even after extended treatment times (i.e., not all lotion dosed into the wipe is releasable).

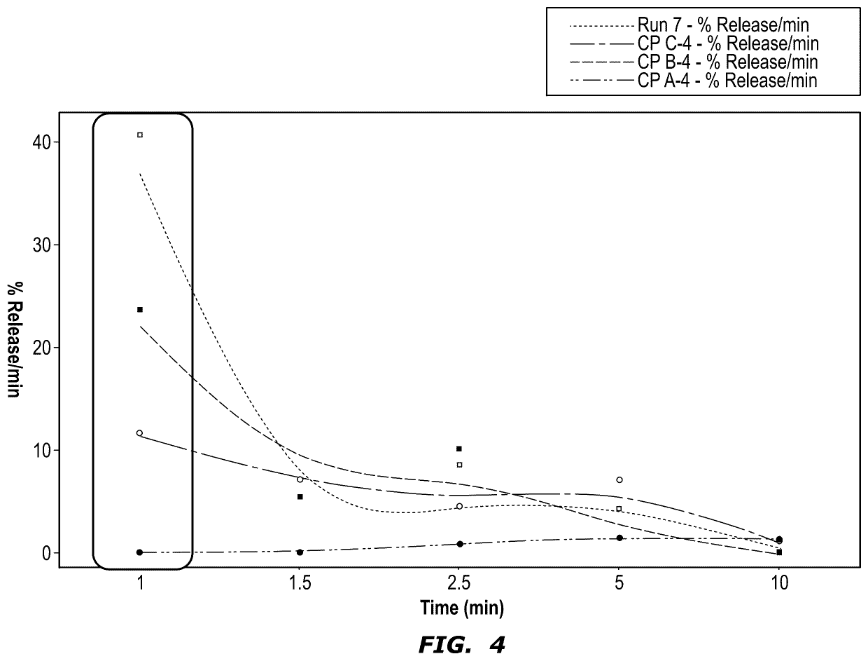

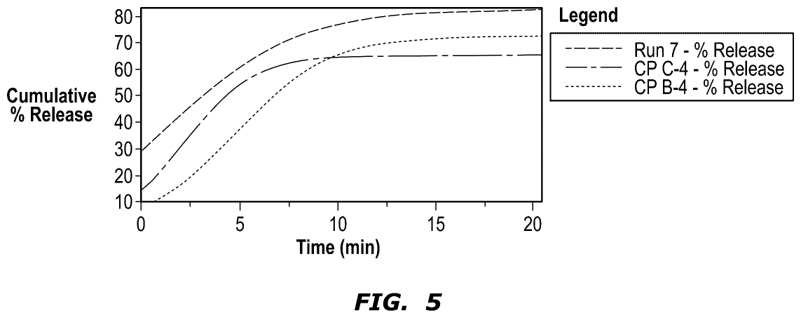

FIG. 4 shows marginal percent release per minute for an exemplary embodiment (e.g., as shown in Tables 2-3 dosed onto a wipe) as compared to various comparative products. Such a test was performed with a 4 lb load size, at 120° F., using a 100% PET substrate at a loading ratio of about 3.6, as compared to the commercially available products shown. As shown in FIG. 4, the percentage of lotion released within the first minute is significantly different for the exemplary products, as compared to the commercially available products. Such a difference allows for a very quick dryer refresh treatment of one or more desired fabric articles, which quickly effective treatment is simply not available, based on the commercially available products.

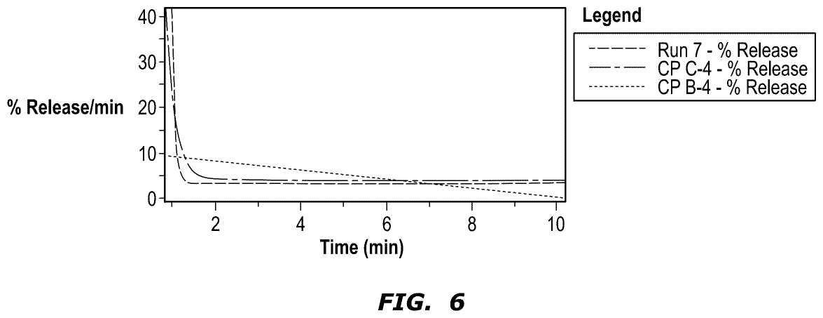

FIG. 5 shows cumulative percentage lotion released over time for an exemplary embodiment as compared to various comparative products. The results show that the exemplary embodiments provide a significant burst effect, where a large fraction of the dosed lotion is very quickly released (e.g., within 1 minute, within 5 minutes, or within 10 minutes), followed by continued release over the next several minutes (e.g., to 20 minutes total dryer treatment time). In addition to providing a faster “burst” type release, the present embodiments provide an overall higher level of release, at any given dryer treatment time. Furthermore, as noted herein, the overall grams of lotion released is also significantly higher, due to the loading and release characteristics of the present embodiments, as compared to comparative products.

FIG. 6 shows rate of release (percent release per minute) versus time for an exemplary embodiment as compared to various comparative products, within the first 10 minutes of treatment. As shown, the present embodiments exhibit a very fast “burst” release of the lotion, within the first few minutes of the treatment cycle. The comparative products do not provide such a benefit. It is noted that the graphs shown in FIGS. 5 and 6 are for the model fit to the data, rather than the data points themselves.

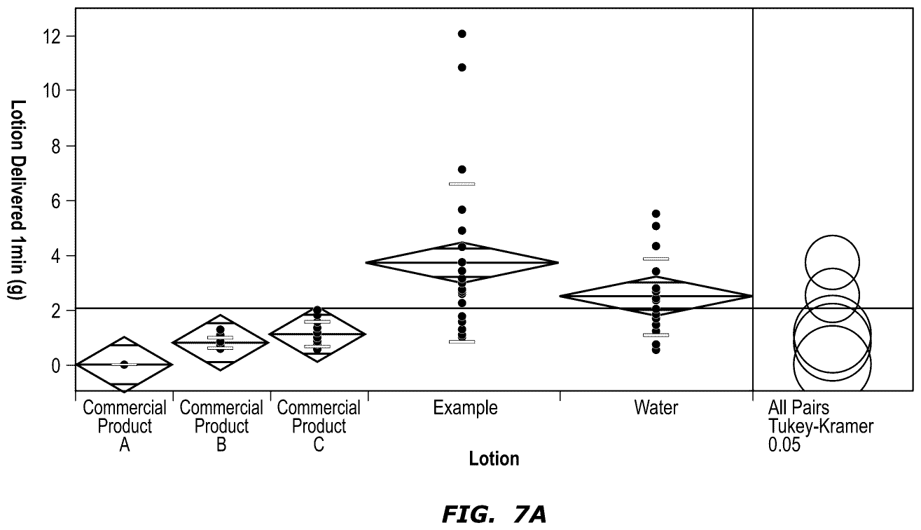

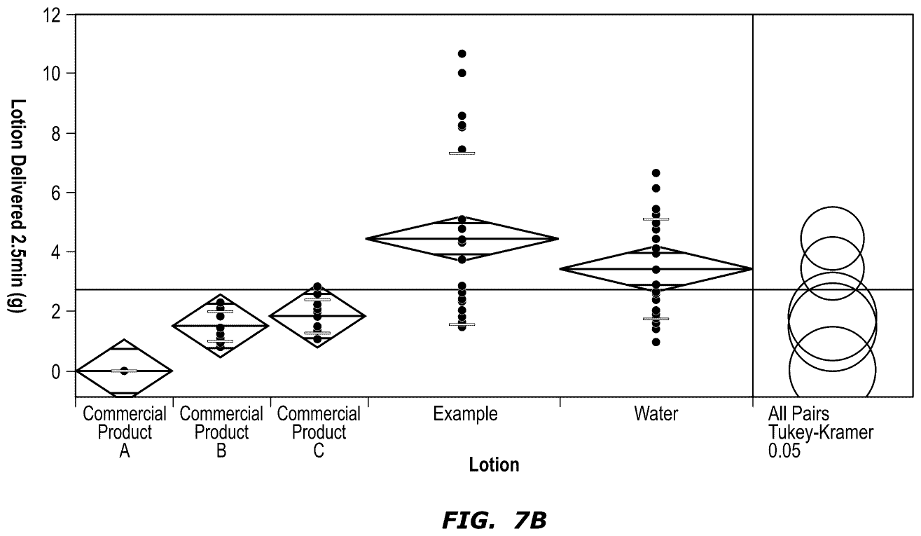

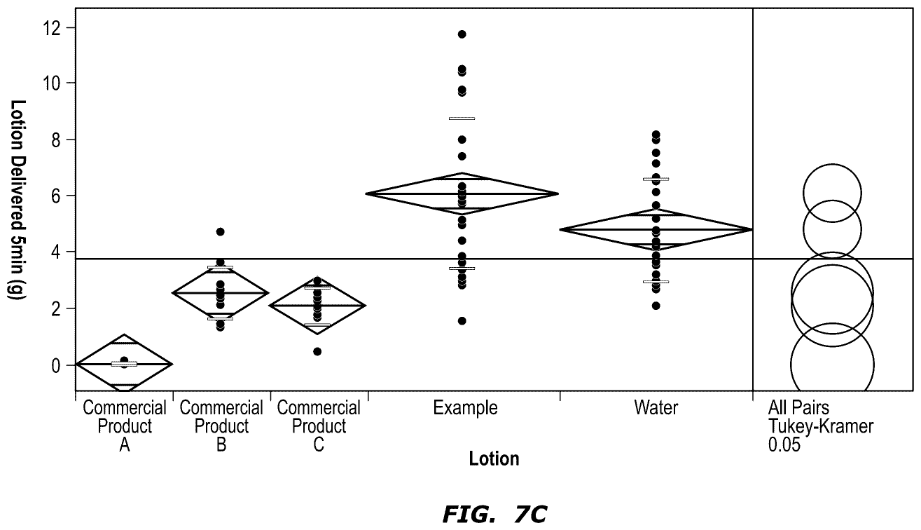

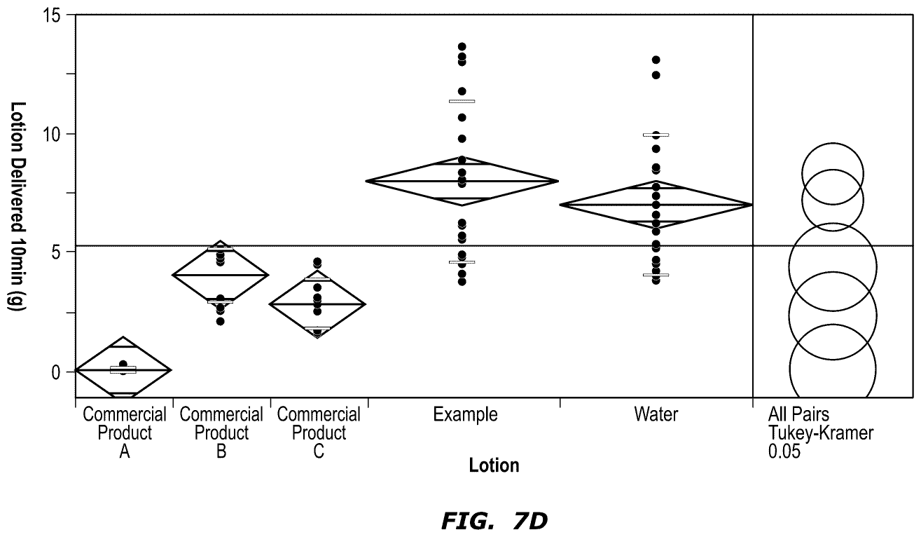

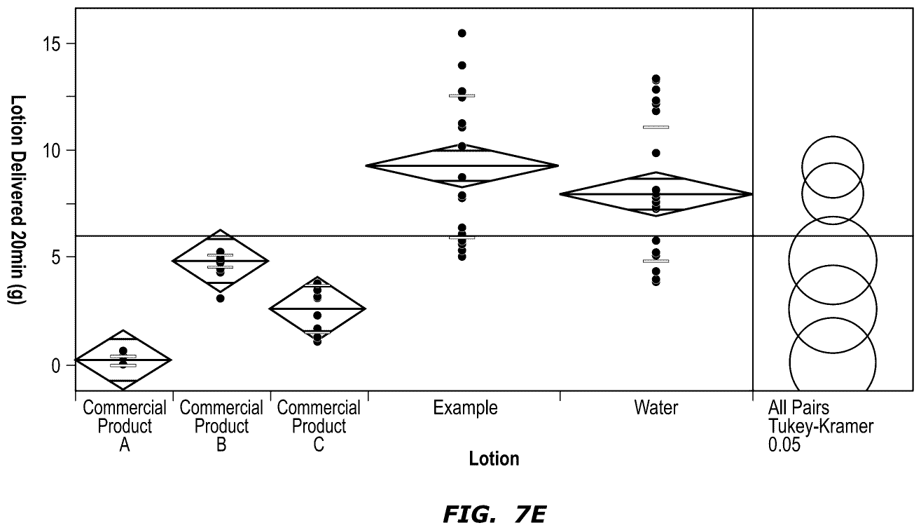

FIG. 7A shows grams of lotion delivered at a treatment time of 1 minute for an exemplary embodiment as compared to various comparative products. FIG. 7B shows grams of lotion delivered at a treatment time of 2.5 minutes for an exemplary embodiment as compared to various comparative products. FIG. 7C shows grams of lotion delivered at a treatment time of 5 minutes for an exemplary embodiment as compared to various comparative products. FIG. 7D shows grams of lotion delivered at a treatment time of 10 minutes for an exemplary embodiment as compared to various comparative products. FIG. 7E shows grams of lotion delivered at a treatment time of 20 minutes for an exemplary embodiment as compared to various comparative products. As shown, the release profile is much more rapid for the present embodiments, as compared to the comparative products. Such a rapid release is advantageous, as it allows a user to very quickly refresh desired articles of clothing within a short period of time (e.g., less than 20 minutes, such as only 10 minutes, only 5 minutes, or even less (e.g., 4 minutes, 3 minutes, 2 minutes or 1 minute), without the need to subject such clothing articles to a full wash and dry cycle, which may be impossible when such a user is in a hurry.

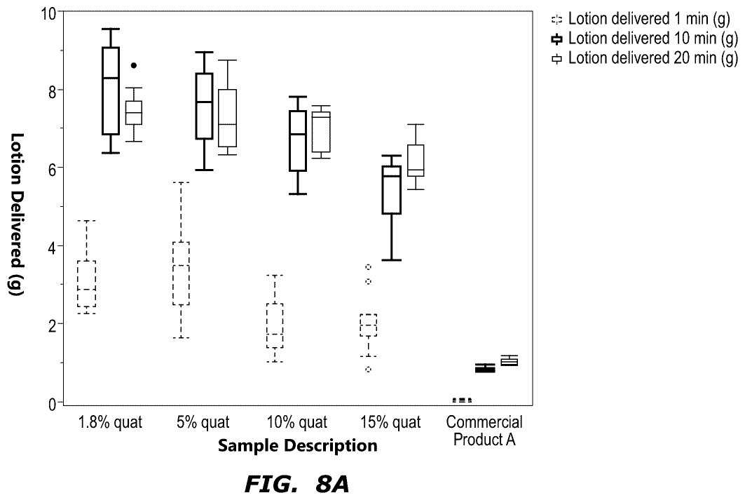

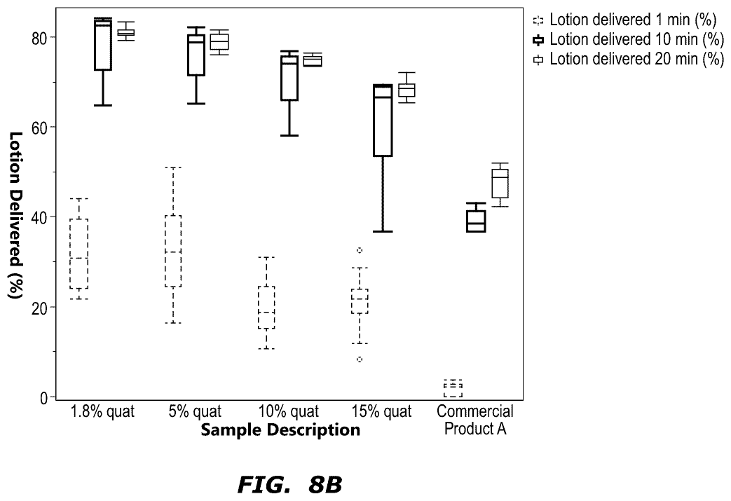

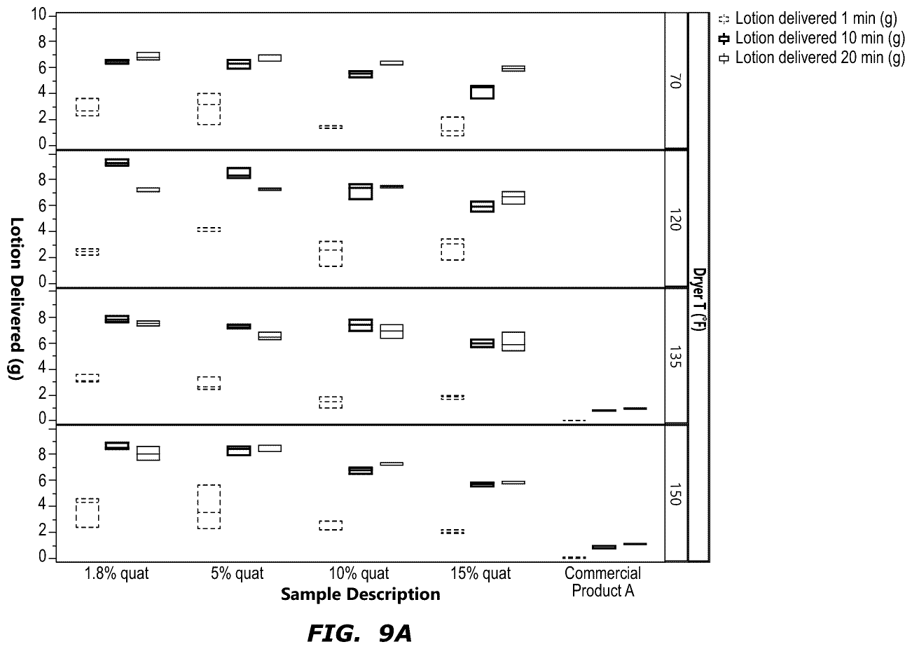

FIG. 8A shows additional data showing grams of lotion delivered at various treatment times (1 minute, 10 minutes, and 20 minutes) for various exemplary embodiments, at different ester quat fabric softening additive loading values. In particular, the exemplary compositions for FIG. 8A are shown in Tables 13A-13C below. Each sample was tested with a load size of 4 lb, using a polycotton ballast, with the tested composition dosed on a PET substrate measuring 7×7 inches, with a basis weight of 52 gsm, at a loading ratio of 5. Table 13A shows data for the 1 minute treatment time, Table 13B shows data for the 10 minute treatment time, and Table 13C shows data for the 20 minute treatment time. The employed fabric softener component included an 88% actives content, so that the nominal percentages of employed fabric softener were higher than the actual values listed in the tables. The employed nonionic surfactant included 100% actives content, so there is no difference between nominal surfactant content and active surfactant content. FIG. 13A also shows data (samples 49-54) for a commercially available dryer sheet product, for comparison.

TABLE 13A

| Sample | % Fabric | % | Dryer | Initial | Weight after |
|---|---|---|---|---|---|
| No. | Softener | Surfactant | Temp. | Weight (g) | 1 min (g) |
| 1 | 5 | 1.67 | 70 | 10.01 | 6.84 |
| 2 | 5 | 1.67 | 70 | 9.98 | 8.35 |
| 3 | 5 | 1.67 | 70 | 9.96 | 5.94 |
| 4 | 5 | 1.67 | 120 | 10.46 | 6.39 |
| 5 | 5 | 1.67 | 120 | 10.57 | 6.25 |
| 6 | 5 | 1.67 | 120 | 10.24 | 6.16 |
| 7 | 5 | 1.67 | 135 | 9.99 | 7.38 |
| 8 | 5 | 1.67 | 135 | 10.17 | 7.74 |
| 9 | 5 | 1.67 | 135 | 10.62 | 7.25 |
| 10 | 5 | 1.67 | 150 | 10.66 | 8.32 |
| 11 | 5 | 1.67 | 150 | 11.03 | 5.42 |
| 12 | 5 | 1.67 | 150 | 11.11 | 7.51 |
| 13 | 10 | 3.33 | 70 | 9.34 | 7.95 |
| 14 | 10 | 3.33 | 70 | 8.98 | 7.44 |
| 15 | 10 | 3.33 | 70 | 9.12 | 7.54 |
| 16 | 10 | 3.33 | 120 | 10.44 | 7.21 |
| 17 | 10 | 3.33 | 120 | 10.5 | 7.91 |
| 18 | 10 | 3.33 | 120 | 10.44 | 9.09 |
| 19 | 15 | 5.00 | 70 | 9.97 | 7.74 |
| 20 | 15 | 5.00 | 70 | 10.06 | 9.23 |
| 21 | 15 | 5.00 | 70 | 9.81 | 8.66 |
| 22 | 15 | 5.00 | 120 | 9.84 | 7.98 |
| 23 | 15 | 5.00 | 120 | 10.75 | 7.67 |
| 24 | 15 | 5.00 | 120 | 10.61 | 7.16 |
| 25 | 1.8 | 0.60 | 70 | 9.45 | 7.11 |
| 26 | 1.8 | 0.60 | 70 | 9.54 | 6.85 |
| 27 | 1.8 | 0.60 | 70 | 9.13 | 5.52 |
| 28 | 1.8 | 0.60 | 120 | 9.46 | 6.92 |
| 29 | 1.8 | 0.60 | 120 | 10.39 | 8.13 |
| 30 | 1.8 | 0.60 | 120 | 11.97 | 9.27 |
| 31 | 1.8 | 0.60 | 135 | 9.09 | 5.99 |
| 32 | 1.8 | 0.60 | 135 | 9.21 | 5.63 |
| 33 | 1.8 | 0.60 | 135 | 9.13 | 6.08 |
| 34 | 1.8 | 0.60 | 150 | 10.12 | 7.71 |
| 35 | 1.8 | 0.60 | 150 | 10.53 | 5.9 |
| 36 | 1.8 | 0.60 | 150 | 10.52 | 6.22 |
| 37 | 10 | 3.33 | 135 | 9.67 | 8.64 |
| 38 | 10 | 3.33 | 135 | 8.9 | 7.47 |
| 39 | 10 | 3.33 | 135 | 9.36 | 7.46 |
| 40 | 10 | 3.33 | 150 | 9.61 | 7.36 |
| 41 | 10 | 3.33 | 150 | 9.75 | 7.49 |
| 42 | 10 | 3.33 | 150 | 9.81 | 6.94 |
| 43 | 15 | 5.00 | 135 | 8.86 | 7.22 |
| 44 | 15 | 5.00 | 135 | 8.49 | 6.6 |
| 45 | 15 | 5.00 | 135 | 9.49 | 7.51 |
| 46 | 15 | 5.00 | 150 | 9.03 | 6.98 |
| 47 | 15 | 5.00 | 150 | 9.12 | 6.9 |
| 48 | 15 | 5.00 | 150 | 9.27 | 7.33 |
| 49 | | | 135 | 2.1 | 2.1 |
| 50 | | | 135 | 2.07 | 2.02 |
| 51 | | | 135 | 2.07 | 2.07 |
| 52 | | | 150 | 2.09 | 2.04 |
| 53 | | | 150 | 2.18 | 2.14 |

| | | | |
|---|---|---|---|
| 54 | 150 | 2.18 | 2.1 |

Table 13B shows the data for 10 minute treatment times.

TABLE 13B

| Sample | % Fabric | % | Dryer | Initial | Weight after |
|---|---|---|---|---|---|
| No. | Softener | Surfactant | Temp. | Weight (g) | 10 min (g) |
| 1 | 5 | 1.67 | 70 | 9.05 | 3.11 |
| 2 | 5 | 1.67 | 70 | 9.46 | 2.88 |
| 3 | 5 | 1.67 | 70 | 9.74 | 3.39 |
| 4 | 5 | 1.67 | 120 | 10.09 | 1.97 |
| 5 | 5 | 1.67 | 120 | 10.31 | 1.97 |
| 6 | 5 | 1.67 | 120 | 10.9 | 1.95 |
| 7 | 5 | 1.67 | 135 | 9.53 | 2.12 |
| 8 | 5 | 1.67 | 135 | 9.39 | 2.11 |
| 9 | 5 | 1.67 | 135 | 9.19 | 2.03 |
| 10 | 5 | 1.67 | 150 | 10.69 | 2.09 |
| 11 | 5 | 1.67 | 150 | 10.53 | 2.1 |
| 12 | 5 | 1.67 | 150 | 9.99 | 2.04 |
| 13 | 10 | 3.33 | 70 | 8.7 | 3.17 |
| 14 | 10 | 3.33 | 70 | 9.14 | 3.83 |
| 15 | 10 | 3.33 | 70 | 9.61 | 3.9 |
| 16 | 10 | 3.33 | 120 | 8.88 | 2.34 |
| 17 | 10 | 3.33 | 120 | 9.75 | 2.38 |
| 18 | 10 | 3.33 | 120 | 10.03 | 2.37 |
| 19 | 15 | 5.00 | 70 | 9.07 | 4.58 |
| 20 | 15 | 5.00 | 70 | 9.91 | 6.28 |
| 21 | 15 | 5.00 | 70 | 9.56 | 5 |
| 22 | 15 | 5.00 | 120 | 9.08 | 2.79 |
| 23 | 15 | 5.00 | 120 | 8.38 | 2.78 |
| 24 | 15 | 5.00 | 120 | 8.62 | 2.66 |
| 25 | 1.8 | 0.60 | 70 | 9.32 | 2.79 |
| 26 | 1.8 | 0.60 | 70 | 9.6 | 3.02 |
| 27 | 1.8 | 0.60 | 70 | 9.83 | 3.46 |
| 28 | 1.8 | 0.60 | 120 | 11.36 | 1.81 |
| 29 | 1.8 | 0.60 | 120 | 11.04 | 1.75 |
| 30 | 1.8 | 0.60 | 120 | 10.9 | 1.81 |
| 31 | 1.8 | 0.60 | 135 | 9.61 | 1.8 |
| 32 | 1.8 | 0.60 | 135 | 9.87 | 1.73 |
| 33 | 1.8 | 0.60 | 135 | 9.45 | 1.81 |
| 34 | 1.8 | 0.60 | 150 | 10.18 | 1.74 |
| 35 | 1.8 | 0.60 | 150 | 10.71 | 1.76 |
| 36 | 1.8 | 0.60 | 150 | 10.33 | 1.78 |
| 37 | 10 | 3.33 | 135 | 9.36 | 2.43 |
| 38 | 10 | 3.33 | 135 | 10.32 | 2.51 |
| 39 | 10 | 3.33 | 135 | 9.72 | 2.26 |
| 40 | 10 | 3.33 | 150 | 9.12 | 2.35 |
| 41 | 10 | 3.33 | 150 | 9.38 | 2.38 |
| 42 | 10 | 3.33 | 150 | 8.9 | 2.38 |
| 43 | 15 | 5.00 | 135 | 8.47 | 2.73 |
| 44 | 15 | 5.00 | 135 | 9.08 | 2.8 |
| 45 | 15 | 5.00 | 135 | 8.86 | 2.82 |
| 46 | 15 | 5.00 | 150 | 8.95 | 3.07 |
| 47 | 15 | 5.00 | 150 | 8.74 | 2.95 |
| 48 | 15 | 5.00 | 150 | 8.47 | 2.92 |
| 49 | | | 135 | 2.12 | 1.28 |
| 50 | | | 135 | 2.1 | 1.33 |
| 51 | | | 135 | 2.17 | 1.36 |
| 52 | | | 150 | 2.02 | 1.2 |
| 53 | | | 150 | 2.12 | 1.34 |
| 54 | | | 150 | 2.23 | 1.27 |

Table 13C shows the data for 20 minute treatment times.

TABLE 13C

| Sample | % Fabric | % | Dryer | Initial | Weight after |
|---|---|---|---|---|---|
| No. | Softener | Surfactant | Temp. | Weight (g) | 20 min (g) |
| 1 | 5 | 1.67 | 70 | 8.42 | 1.9 |
| 2 | 5 | 1.67 | 70 | 8.4 | 1.87 |
| 3 | 5 | 1.67 | 70 | 8.89 | 1.85 |
| 4 | 5 | 1.67 | 120 | 9.07 | 1.9 |
| 5 | 5 | 1.67 | 120 | 9.17 | 1.92 |
| 6 | 5 | 1.67 | 120 | 9.24 | 1.86 |
| 7 | 5 | 1.67 | 135 | 8.91 | 2.04 |
| 8 | 5 | 1.67 | 135 | 8.32 | 1.99 |
| 9 | 5 | 1.67 | 135 | 8.44 | 2 |
| 10 | 5 | 1.67 | 150 | 10.14 | 1.95 |
| 11 | 5 | 1.67 | 150 | 10.23 | 1.97 |
| 12 | 5 | 1.67 | 150 | 10.74 | 1.99 |
| 13 | 10 | 3.33 | 70 | 8.51 | 2.26 |
| 14 | 10 | 3.33 | 70 | 8.86 | 2.33 |
| 15 | 10 | 3.33 | 70 | 8.45 | 2.21 |
| 16 | 10 | 3.33 | 120 | 9.67 | 2.32 |
| 17 | 10 | 3.33 | 120 | 9.92 | 2.33 |
| 18 | 10 | 3.33 | 120 | 9.89 | 2.45 |
| 19 | 15 | 5.00 | 70 | 8.71 | 2.75 |
| 20 | 15 | 5.00 | 70 | 8.84 | 2.69 |
| 21 | 15 | 5.00 | 70 | 8.37 | 2.64 |
| 22 | 15 | 5.00 | 120 | 8.83 | 2.71 |
| 23 | 15 | 5.00 | 120 | 9.3 | 2.6 |
| 24 | 15 | 5.00 | 120 | 9.85 | 2.76 |
| 25 | 1.8 | 0.60 | 70 | 8.61 | 1.77 |
| 26 | 1.8 | 0.60 | 70 | 8.4 | 1.74 |
| 27 | 1.8 | 0.60 | 70 | 8.99 | 1.78 |
| 28 | 1.8 | 0.60 | 120 | 9.19 | 1.77 |
| 29 | 1.8 | 0.60 | 120 | 9.12 | 1.76 |
| 30 | 1.8 | 0.60 | 120 | 8.75 | 1.7 |
| 31 | 1.8 | 0.60 | 135 | 9.12 | 1.76 |
| 32 | 1.8 | 0.60 | 135 | 9.26 | 1.75 |
| 33 | 1.8 | 0.60 | 135 | 9.45 | 1.73 |
| 34 | 1.8 | 0.60 | 150 | 9.31 | 1.74 |
| 35 | 1.8 | 0.60 | 150 | 9.75 | 1.72 |
| 36 | 1.8 | 0.60 | 150 | 10.34 | 1.73 |
| 37 | 10 | 3.33 | 135 | 8.63 | 2.28 |
| 38 | 10 | 3.33 | 135 | 9.4 | 2.45 |
| 39 | 10 | 3.33 | 135 | 9.89 | 2.46 |
| 40 | 10 | 3.33 | 150 | 9.75 | 2.36 |
| 41 | 10 | 3.33 | 150 | 9.79 | 2.4 |
| 42 | 10 | 3.33 | 150 | 9.61 | 2.4 |
| 43 | 15 | 5.00 | 135 | 8.15 | 2.71 |
| 44 | 15 | 5.00 | 135 | 9.96 | 3.11 |
| 45 | 15 | 5.00 | 135 | 8.88 | 2.96 |
| 46 | 15 | 5.00 | 150 | 8.78 | 3.01 |
| 47 | 15 | 5.00 | 150 | 8.87 | 3.08 |
| 48 | 15 | 5.00 | 150 | 8.75 | 2.85 |
| 49 | | | 135 | 2.12 | 1.17 |
| 50 | | | 135 | 2.2 | 1.27 |
| 51 | | | 135 | 2.1 | 1.08 |
| 52 | | | 150 | 2.27 | 1.09 |
| 53 | | | 150 | 2.14 | 1.07 |
| 54 | | | 150 | 2.1 | 1.07 |

FIG. 8B is for the same test results shown in FIG. 8A and Tables 13A-13C, but shows the weight percent of lotion delivered at the various tested treatment times (1 minute, 10 minutes, and 20 minutes) for the tested different ester quat fabric softening additive loading values. Data for a commercially available dryer sheet product is also shown, for comparison.

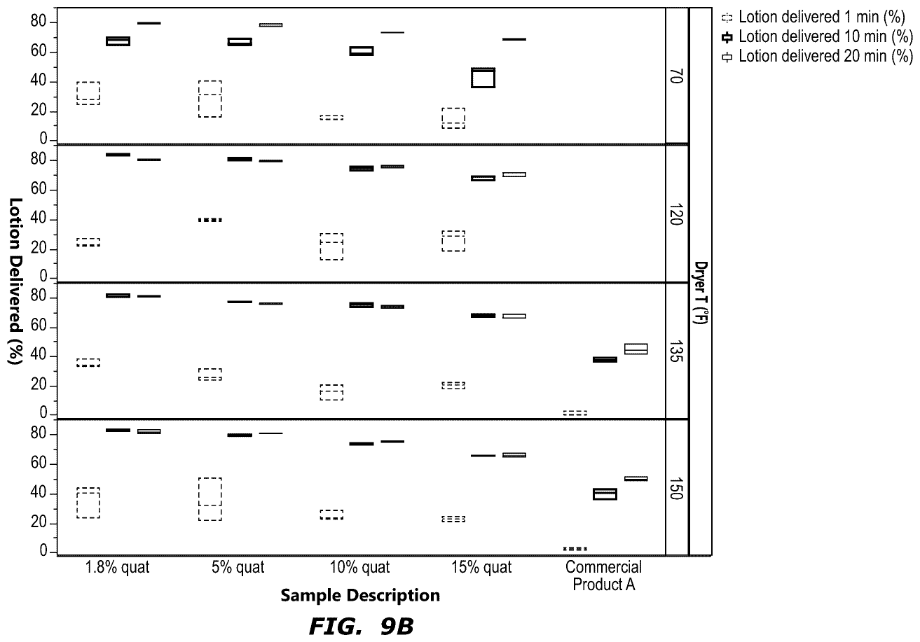

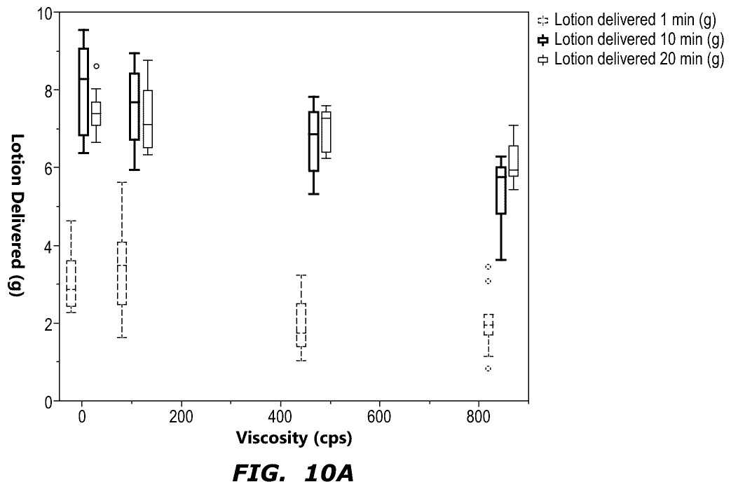

FIG. 9A is also for the same test results shown in FIGS. 8A-8B and Tables 13A-13C, with the data broken out separately for the different tested treatment temperatures (70° F., 120° F., 135° F., and 150° F.). Data for the commercially available dryer sheet product is also shown, for comparison.

FIG. 9B is also for the same test results shown in FIGS. 8A-8B and Tables 13A-13C, with the data broken out separately for the different tested treatment temperatures (70° F., 120° F., 135° F., and 150° F.), but shows the weight percent of lotion delivered, rather than grams of lotion delivered (as compared to FIG. 9A). Data for the commercially available dryer sheet product is also shown, for comparison.

FIGS. 10A-10C illustrate the effect of different viscosity values for the compositions, on lotion release. Testing parameters (e.g., load size, ballast, wipe substrate, and loading ratio) were similar to those described above relative to FIGS. 8A-9B. FIG. 10A shows grams of lotion delivered at various treatment times (1 minute, 10 minutes, and 20 minutes) for various exemplary embodiments, at different viscosity values.

FIG. 10B is for the same test results shown in FIG. 10A, but shows the weight percent of lotion delivered at various treatment times (1 minute, 10 minutes, and 20 minutes) for the various tested exemplary embodiments, at different viscosity values.

FIG. 10C shows weight percent of lotion delivered at various treatment times (1 minute, 10 minutes, and 20 minutes) for various exemplary embodiments, at different viscosity values, additionally broken down for different ester quat fabric softening additive loading values.

FIG. 11A shows viscosity data for the various exemplary embodiments of FIGS. 10A-10C, showing increased viscosity and more pronounced shear thinning with increased fabric softening additive. As the employed fabric softener component included an 88% actives content, the nominal percentages of employed fabric softener were higher than the actual listed percentages. FIG. 11A illustrates how at a low fabric softener loading (e.g., 1.8%), shear thinning behavior is minimal, with the composition exhibiting a viscosity ranging from about 1.8 to about 3 cps. At the higher fabric softener loading values, shear thinning behavior is more pronounced, with measured viscosity changing significantly depending on applied shear rate, as shown in Table 14. Fabric softener and surfactant are denoted as FS and Surf. in Table 14.

TABLE 14

| | Formula | Formula | Formula | Formula | Formula |
|---|---|---|---|---|---|
| | 1 | 2 | 3 | 4 | 5 |
| | (1.8% FS | (5% FS | (10% FS | (15% FS | (20% FS |
| | 0.6% | 1.67% | 3.33% | 5% | 6.67% |
| Label | Surf.) | Surf.) | Surf.) | Surf.) | Surf.) |
| FS (% active) | 1.8 | 5 | 10 | 15 | 20 |
| Surfactant (% | 0.6 | 1.67 | 3.33 | 5 | 6.67 |
| active) | | | | | |
| Gamma (Total | 2.4 | 6.7 | 13.3 | 20 | 26.7 |
| Actives) | | | | | |
| Delta (proportion | 0.75 | 0.75 | 0.75 | 0.75 | 0.75 |
| of FS) | | | | | |
| Shear rate = 0.1/s | 2.97 | 105.7 | 466.6 | 844 | 1246 |
| Shear rate = 1/s | 2.07 | 27.0 | 172.9 | 419 | 781 |
| Shear rate = 10/s | 1.93 | 9.5 | 40.9 | 127 | 301 |
| Shear rate = 100/s | 1.80 | 5.4 | 14.5 | 34 | 80 |
| Shear rate = 1000/s | 1.81 | 4.4 | 8.6 | 18 | 37 |

FIG. 11B plots the data from Table 14, plotting viscosity versus gamma (total actives content). FIG. 11B clearly illustrates the shear thinning effect associated with higher actives loading.

Without departing from the spirit and scope of this invention, one of ordinary skill can make various modifications to the invention to adapt it to various usages and conditions. As such, these changes and modifications are properly, equitably, and intended to be, within the full range of equivalence of the following claims.

1. A method for providing a refresh treatment within a dryer, the method comprising:
(a) providing a dryer refresh composition dosed onto a wipe or other substrate, the refresh composition comprising:
(i) from about 0.5% to about 15% by weight of a fabric softening additive;
(ii) from about 0.01% to about 15% by weight of at least one of a nonionic, cationic, or zwitterionic surfactant; and
(iii) water;
wherein the wipe or other substrate includes the refresh composition dosed thereon;
(b) placing the wipe or other substrate dosed with the dryer refresh composition into a fabric article drying appliance with one or more dry fabric articles in order to refresh such fabric articles without subjecting such fabric articles to a wash cycle; and
(c) treating the one or more fabric articles in the fabric article drying appliance with the wipe or other substrate dosed with the dryer refresh composition wherein at least 60% of the dryer refresh composition releases from the wipe within about 20 minutes at a temperature of no greater than about 145° F.

2. The method of claim 1, wherein the fabric softening additive comprises at least one of (i) an ester quat or other cationic fabric softener additive, (ii) a phosphate ester anionic fabric softener additive or other anionic fabric softener additive, or (iii) a fatty acid fabric softener additive or other non-ionic fabric softener additive.

3. The method of claim 1, wherein the fabric softener additive comprises an ester quat and is present in an amount of from about 1% to about 10% by weight.

4. The method of claim 1, wherein the surfactant comprises an alcohol ethoxylate nonionic surfactant.

5. The method of claim 1, wherein the surfactant is present in an amount of from about 0.3% to about 10% by weight.

6. The method of claim 1, wherein the refresh composition further comprises at least one of a fragrance or non-fragrance odor control additive.

7. The method of claim 6, wherein the fragrance is present in an amount of from greater than 0% to about 10% by weight.

8. The method of claim 1, wherein the composition comprises a fragrance, enzyme, probiotic, or other component that would exhibit a loss of functional properties at temperatures of greater than about 145° F.

9. The method of claim 1, wherein the water is present in an amount of at least about 30%, at least about 40%, at least about 50%, at least about 60%, at least about 70%, at least about 80% or at least about 90% by weight.

10. The method of claim 1, wherein the water is present in an amount of at least about 95% by weight.

11. The method of claim 1, wherein the fabric article drying appliance provides a temperature to the one or more fabric articles and the dryer refresh composition that is from about 70° F. to about 110° F.

12. The method of claim 1, wherein the fabric article drying appliance provides a temperature to the one or more fabric articles and the dryer refresh composition that is from about 70° F. to about 90° F.

13. The method of claim 1, wherein the fabric article drying appliance provides a temperature to the one or more fabric articles and the dryer refresh composition that is from about 90° F. to about 110° F.

14. The method of claim 1, wherein at least 50% of the dryer refresh composition releases from the wipe or other substrate within about 5 minutes at a temperature of no greater than about 145° F., about 140° F., about 135° F., about 130° F., about 125° F. or about 120° F.

15. The method of claim 1, wherein the one or more fabric articles are treated in the fabric article drying appliance with the wipe or other substrate dosed with the dryer refresh composition for no more than 15 minutes at a temperature of no greater than about 145° F., about 140° F., about 135° F., about 130° F., about 125° F. or about 120° F.

16. The method of claim 1, wherein the one or more fabric articles are treated in the fabric article drying appliance with the wipe or other substrate dosed with the dryer refresh composition for a period of time of from 1 to 15 minutes at a temperature of no greater than about 145° F., about 140° F., about 135° F., about 130° F., about 125° F. or about 120° F.

17. The method of claim 1, wherein the one or more fabric articles are treated in the fabric article drying appliance with the wipe or other substrate dosed with the dryer refresh composition for a period of time of from 1 to 10 minutes at a temperature of no greater than about 145° F., about 140° F., about 135° F., about 130° F., about 125° F. or about 120° F.

18. The method of claim 1, wherein the one or more fabric articles are treated in the fabric article drying appliance with the wipe or other substrate dosed with the dryer refresh composition for a period of time of from 1 to 5 minutes at a temperature of no greater than about 145° F., about 140° F., about 135° F., about 130° F., about 125° F. or about 120° F.

19. The method of claim 1, wherein the wipe or other substrate comprises at least one of a structure containing fiber materials, a knit article, a woven article, a nonwoven article, a sponge, a sheet, a cloth, a foam, or a pad.

20. The method of claim 1, wherein the refresh composition is a liquid composition.

21. A method for providing a refresh treatment within a dryer, the method comprising:
(a) providing a dryer refresh composition dosed onto a wipe or other substrate, the refresh composition comprising:
(i) from about 1% to about 3% by weight of a fabric softening additive;
(ii) from about 0.3% to about 1% by weight of a nonionic surfactant; and
(iii) greater than about 95% by weight water;
wherein the wipe or other substrate includes the refresh composition dosed thereon;
(b) placing the wipe or other substrate dosed with the dryer refresh composition into a fabric article drying appliance with one or more dry fabric articles in order to refresh such fabric articles without subjecting such fabric articles to a wash cycle; and
(c) treating the one or more fabric articles in the fabric article drying appliance with the wipe or other substrate dosed with the dryer refresh composition for a period of from about 1 minute to about 20 minutes at a temperature of no greater than about 145° F., about 140° F., about 135° F., about 130° F., about 125° F. or about 120° F.

22. A method for providing a refresh treatment within a dryer, the method comprising:
(a) providing a dryer refresh composition dosed onto a wipe or other substrate, the refresh composition consisting of:
(i) from about 1% to about 3% by weight of a fabric softener additive;
(ii) from about 0.3% to about 1% by weight of a nonionic surfactant; and
(iii) greater than about 95% by weight water;
(iv) optionally, one or more of the following adjuncts selected from the group consisting of: fragrances or perfumes, antimicrobial actives, microbiostatic agents, fluorescent whitening agents, waterproofing agents, anti-pilling agents, probiotics, solvents, dyes or colorants, solubilizing materials, stabilizers, thickeners, defoamers, hydrotropes, buffers, builders, lotions or mineral oils, enzymes, cloud point modifiers, odor control additives, additional fabric softeners, antistatic agents, siloxanes, wrinkle release agents, allergen neutralization agents, skin-enhancing agents, allergen-free additives, fabric longevity enhancers, and preservatives;
wherein the dosed wipe or other substrate is free of waxes and fabric softeners that are dry solids at room temperature;
wherein the wipe or other substrate includes the refresh composition dosed thereon;
(b) placing the wipe or other substrate dosed with the dryer refresh composition into a fabric article drying appliance with one or more dry fabric articles in order to refresh such fabric articles without subjecting such fabric articles to a wash cycle; and
(c) treating the one or more fabric articles in the fabric article drying appliance with the wipe or other substrate dosed with the dryer refresh composition;
wherein at least 60% of the dryer refresh composition releases from the wipe within about 20 minutes at a temperature of no greater than about 145° F., about 140° F., about 135° F., about 130° F., about 125° F. or about 120° F.

23. The method of claim 22, wherein the refresh composition is substantially free of materials derived from petrochemicals.

24. The method of claim 22, wherein the refresh composition is substantially derived from plant-based materials.

25. The method of claim 22, wherein the refresh composition is not corrosive to eyes per a Bovine Corneal Opacity and Permeability Assay (e.g., BCOP, OECD 437).

26. The method of claim 22, wherein the refresh composition is not corrosive to skin per a Skin Corrosion Test (e.g., OECD 431).

27. The method of claim 22, wherein the refresh composition is substantially free of allergens.

28-75. (canceled)
